(19) United States
(12) Patent Application Publication
(10) Pub. No.: US 2009/0059295 A1
(43) Pub. Date: Mar. 5, 2009

(54) Plotting Device and Image Data Creation Method

(76) Inventors: Mitsuru Mushano, Tokyo (JP); Yuri Kashiwai, Chiba-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/992,849

(22) PCT Filed: Sep. 29, 2006
(86) PCT No.: PCT/JP2006/319504

§ 371 Date: Mar. 31, 2008

(30) Foreign Application Priority Data
Sep. 30, 2005 (JP) 2005-286613

(51) Int. Cl. G06K 15/00

(52) U.S. Cl. 358/1.16

(57) ABSTRACT

When a pixel pitch formed on a substrate is different from a micro mirror read pitch, image data is stored as divided image data having continuous memory addresses in a memory. It is possible to read data from the divided image data by memory read means rapidly (in a short time) so as to create mirror data.

### TECHNICAL FIELD

The present invention relates to an image plotting (recording) apparatus (device) for relatively moving image recording dot forming elements in a scanning direction on an image recording surface based on image data comprising pixel data for forming an image so as to form a sequence of image recording dots on the image recording surface, thereby forming an image on the image recording surface, and a method of generating (creating) image data.

The present invention is also concerned with an image recording apparatus for relatively moving image recording dot forming elements at a prescribed feed pitch along a normal scanning direction on an image recording surface based on image data comprising pixel data for forming an image, thereby to form an intermittent sequence of image recording dots on the image recording surface, and also relatively moving image recording dot forming elements at the prescribed feed pitch along an inverse scanning direction that is opposite to the normal scanning direction so as to form an intermittent sequence of image recording dots, which fill up the above intermittent sequence of image recording dots, on the image recording surface, for thereby forming an image made up of a successive sequence of image recording dots on the image recording surface, and a method of generating image data.

### BACKGROUND ART

Heretofore, there have been proposed various exposure apparatus based on the technology of photolithography for recording a prescribed pattern on a printed-wiring board or a flat panel display substrate.

One such exposure apparatus produces a wiring pattern by scanning a substrate coated with a photoresist, for example, with a light beam in a main scanning direction and an auxiliary scanning direction, and modulating the light beam with image data representing the wiring pattern.

There have been proposed various exposure apparatus for modulating a light beam based on image data with a spatial light modulator such as a digital micromirror device (DMD) or the like, for example.

A DMD comprises a number of micromirrors disposed two-dimensionally on the memory array (SPAM array) on a semiconductor substrate of silicon or the like. The micromirrors are tilted by electrostatic forces of charges that are accumulated in the memory array, changing the angles of the reflecting surfaces of the micromirrors for thereby forming desired image recording dots at desired positions on an image recording surface to form an image thereon.

The applicant of the present application has proposed an exposure apparatus for moving a DMD in a scanning direction while the DMD is being tilted with respect to the scanning direction on an exposure surface (Japanese Laid-Open Patent Publication No. 2004-009595).

In the exposure apparatus disclosed in Japanese Laid-Open Patent Publication No. 2004-009595, the DMD is tilted with respect to the scanning direction on the exposure surface to reduce the pitch of scanning paths (scanning lines) of an exposure beam to increase the resolution in a direction perpendicular to the scanning direction, and one scanning line is exposed by different arrays of micromirrors overlappingly to reduce image irregularities.

In the above exposure apparatus, it is assumed, as shown in a schematic diagram of FIG. 42, that a pixel pitch and an inter-readout pitch are different from each other, e.g., the pixel pitch (image resolution) is 1 [μm], for example, and a feed pitch of a DMD 2 in a scanning direction (the inter-readout pitch of readout positions for pixel data) is 2 [μm] which is twice the pixel pitch.

According to the example shown in FIG. 42, image data 200 made of pixel data are stored in a memory (including a hard disk and a main memory), and a sequence of image recording dots corresponding to one scanning line is formed on a substrate based on a second line of image data among the image data 200, for example. The single sequence of image recording dots is formed when mirrors A, B are actuated per inter-readout pitch. Since the inter-readout pitch of the mirror (micromirror) A and the inter-readout pitch of the mirror (micromirror) B are out of phase with each other by a ½ pitch, the pixel data in a sequence of pixels “2, 4, 6, 8, 10” are read out for the mirror A by a memory reading means and supplied to the mirror A, which exposes the substrate to form image recording dots thereon, and the pixel data in a sequence of pixels “1, 3, 5, 7, 9” are read out for the mirror B by the memory reading means and supplied to the mirror B, which exposes the substrate to form image recording dots thereon. In this manner, an image comprising a sequence of image recording dots corresponding to a single scanning line which is made up of image recording dots on the second line of the pixels 1 through 10 is formed on the image recording surface.

However, the memory reading means takes long time in memory control to read the image data by accessing discretely positioned memory addresses, i.e., by accessing every other memory address, and the scanning time is limited by the accessing time required to read the memory.

For producing a multilayer printed-wiring board with the above exposure apparatus, it is necessary to positionally align the wiring patterns on the respective layers a highly accurately. However, the board tends to be deformed due to the heat applied to the board in a pressing process for bonding the layers together. If the layers are exposed to respective wiring patterns at preset positions, then the recorded positions of the wiring patterns on the layers may be misaligned with each other, making it difficult to positionally align the wiring patterns on the layers highly accurately. Furthermore, when the substrate of a flat panel display, for example, is exposed to color filter patterns, the substrate tends to be expanded and contracted by the heat during heat-treating of the substrate, possibly causing recorded positions of colors R, G, B to be misaligned with each other. Moreover, if a substrate is scanned by a light beam while the substrate is moving in a prescribed scanning direction, then the direction in which the substrate moves may be shifted depending on the accuracy with which a moving mechanism for moving the substrate is controlled. Such a directional shift also makes it difficult to bring wiring patterns into positional alignment with a high level of accuracy.

If the substrate is expanded and contracted in the scanning direction, then it is necessary to correct the length of the image to be formed on the image recording surface. The length of the image may be corrected by adding pixel data to the image data or deleting pixel data from the image data. However, the addition or deletion of pixel data makes it more complex to perform memory access control for reading the memory.

### DISCLOSURE OF THE INVENTION

The present invention has been made in view of the above problems. It is an object of the present invention to provide an image recording apparatus which is capable of reading out data from image data at a high speed (in a short time) with a memory reading means even if a pixel pitch and an inter-readout pitch of readout positions for pixel data of an image (image recording dot forming elements) formed by micromirrors or the like are different from each other, and a method of generating image data.

It is also an object of the present invention to provide an image recording apparatus which is capable of reading out data from image data at a high speed (in a short time) with a memory reading means even if a pixel pitch and an inter-readout pitch of readout positions for pixel data of an image (image recording dot forming elements) formed by micromirrors or the like are different from each other, and also if pixel data are added to or deleted from the image data, and a method of generating image data.

It is also an object of the present invention to provide an image recording apparatus which is of a simple arrangement for correcting the length of an image to be formed on an image recording surface, and a method of generating image data.

According to the present invention, an image recording apparatus for relatively moving a plurality of image recording dot forming elements in a scanning direction on an image recording surface at a predetermined feed pitch based on image data comprising pixel data for forming an image so as to form a sequence of image recording dots on the image recording surface, thereby forming the image on the image recording surface, comprises storage means for storing the image data as divided image data if a pixel pitch of the pixel data and the feed pitch are different from each other, wherein the divided image data are divided such that the image data are in phase with respective recording dot forming positions in the scanning direction of the image recording dot forming elements, and the scanning direction and a direction of successive memory addresses of the storage means are aligned with each other.

According to the present invention, since the image data comprising pixel data for forming the image are stored in the storage means as the divided image data previously divided such that they are in phase with respective image forming positions in the scanning direction of the image recording dot forming elements and the scanning direction and the direction of successive memory addresses are aligned with each other, data can be read out from the divided image data by memory reading means at a high speed (in a short time) even if the pixel pitch and the feed pitch for the image recording dot forming elements are different from each other. According to the present invention, an image recording apparatus for relatively moving a plurality of image recording dot forming elements in a scanning direction on an image recording surface based on image data comprising pixel data so as to form a sequence of image recording dots on the image recording surface, thereby forming an image on the image recording surface, comprises storage means for storing divided image data divided from the image data for each of the phases along a readout direction of readout positions for the pixel data for controlling the image recording dot forming elements in the image data.

According to the present invention, since the image data are divided for each of the phases of the image recording dot forming elements and stored as the divided image data in the storage means, the divided image data for each of the phases of the image recording dot forming elements can easily be processed.

The image recording apparatus preferably further comprises access means for reading out the pixel data to be given to the image recording dot forming elements from the divided image data for each of the phases.

The access means preferably reads out the pixel data from the divided image data for each of the image recording dot forming elements.

The divided image data are preferably stored such that the scanning direction and the direction of successive memory addresses of the storage means are aligned with each other.

With the above arrangement, the image recording apparatus may further comprise access means for reading out the pixel data to be given to the image recording dot forming elements from the divided image data for each of the phases, wherein the access means successively reads a plurality of the pixel data from the divided image data for each of the image recording dot forming elements.

Depending on relative movement of the image recording dot forming elements, the pixel data read out for each of the image recording dot forming elements are preferably given in a time sequence to the image recording dot forming elements to form the sequence of image recording dots.

The image recording dot forming elements which are arrayed in the scanning direction and spaced from each other preferably record the image recording dots in respective positions which are close to each other.

The phases corresponding to the respective image recording dot forming elements are preferably determined depending on the array pattern of the image recording dot forming elements with respect to the image recording surface.

Each of the divided image data is preferably compressed.

The pixel data is preferably read out in an at least partly compressed state from the divided image data corresponding to the readout phases with respect to each of the image recording dot forming elements.

If an inter-readout pitch of the readout positions for the pixel data is an integral multiple of the pixel data, the divided image data should preferably be divided into pixel data sequences perpendicular to the scanning direction.

If an inter-readout pitch of the readout positions for the pixel data is a rational multiple of the pixel data, the divided image data should preferably be generated in phase with respective recording dot forming positions in the scanning direction of the image recording dot forming elements from resolution-converted image data whose pixel pitch has been converted into a high resolution by which the inter-readout pitch is divisible.

According to the present invention, if an inter-readout pitch of the readout positions for the pixel data is not an integral multiple of the pixel data, but a rational multiple of the pixel data, the divided image data in phase with respective image forming positions in the scanning direction of the image recording dot forming elements are generated from resolution-converted image data which are produced by converting the resolution of the pixel pitch into a resolution to produce divided image data such that the inter-readout pitch is exactly divisible (meaning that when a real number A is divided by a real number B, an integral quotient is produced as the quotient without a remainder), and are stored in the storage means. Consequently, the divided image data at successive memory addresses are obtained.

If the pixel pitch is rational P times the inter-readout pitch, the number of different readout phases of the image recording dot forming elements is represented by the numerator R of an irreducible fraction P=R/Q representing the rational P, and the divided image data of an Nth (N=0, 1, . . . , Q−1) phase are generated by reading out pixel data in a sequence determined by an integer part of P×i (i=0, 1, . . . )+N/Q from the image data with respect to each of the image recording dot forming elements of the different readout phases. The divided image data at successive memory addresses can similarly be obtained.

If pixel data are added to or deleted from the image data to correct the length of the image to be formed on the image recording surface, corresponding pixel data are added to or deleted from the divided image data, and the divided image data are reassigned to each of the image recording dot forming elements to allow the successive memory addresses of the storage means to be continuously accessed and read subsequently to the added or deleted pixel data in the scanning direction. Therefore, even if the image is corrected for length, the successive memory addresses of the storage means can continuously be accessed and read.

If pixel data are read out from the storage means which stores the divided image data to correct the length of the image to be formed on the image recording surface, the pixel data are read out by skipping or repeating memory addresses which store pixel data for deleting or adding image recording dots. The image data can thus be corrected for length without reassigning the divided image data.

According to the present invention, a method of generating image data for use in relatively moving a plurality of image recording dot forming elements in a scanning direction on an image recording surface at a predetermined feed pitch based on image data comprising pixel data for forming an image so as to form a sequence of image recording dots on the image recording surface, thereby forming an image on the image recording surface, comprises a divided image data generating step of storing, in a storage means, the image data as divided image data if a pixel pitch of the pixel data and the feed pitch are different from each other, the divided image data being divided such that the image data are in phase with respective recording dot forming positions in the scanning direction of the image recording dot forming elements and the scanning direction and a direction of successive memory addresses are aligned with each other.

According to the present invention, in the divided image data generating step, since the image data comprising pixel data for forming the image are stored in the storage means as the divided image data divided such that they are in phase with respective recording dot forming positions in the scanning direction of the image recording dot forming elements and the scanning direction and the direction of successive memory addresses are aligned with each other, data can be read out from the divided image data by memory reading means at a high speed (in a short time) even if the pixel pitch and the feed pitch for the image recording dot forming elements are different from each other.

According to the present invention, a method of generating image data for use in relatively moving a plurality of image recording dot forming elements in a scanning direction on an image recording surface based on image data comprising pixel data so as to form a sequence of image recording dots on the image recording surface, thereby forming an image on the image recording surface, comprises a dividing step of generating divided image data divided from the image data for each of phases along a readout direction of readout positions for the pixel data for controlling the image recording dot forming elements in the image data, and a storing step of storing the divided image data in a storage means.

According to the present invention, since the image data are divided for each of the phases of the image recording dot forming elements and stored as the divided image data in the storage means, the divided image data for each of the phases of the image recording dot forming elements can easily be processed.

The method should preferably further comprise an access step of reading out, with access means, the pixel data to be given to the image recording dot forming elements from the divided image data for each of the phases.

The access means should preferably read out the pixel data from the divided image data for each of the image recording dot forming elements.

In the storing step, the divided image data should preferably be stored such that the scanning direction and the direction of successive memory addresses of the storage means are aligned with each other.

The method may further comprise an access step of reading, with access means, the pixel data to be given to the image recording dot forming elements from the divided image data for each of the phases, wherein in the access step, a plurality of the pixel data may be successively read out from the divided image data for each of the image recording dot forming elements.

For forming the sequence of image recording dots, depending on relative movement of the image recording dot forming elements, the pixel data read out for each of the image recording dot forming elements should preferably be given in a time sequence to the image recording dot forming elements to form the sequence of image recording dots.

The image recording dot forming elements which are arrayed in the scanning direction and spaced from each other should preferably record the image recording dots in respective positions which are close to each other.

The phases corresponding to the respective image recording dot forming elements are preferably determined depending on the array pattern of the image recording dot forming elements with respect to the image recording surface.

Each of the divided image data is preferably compressed.

The pixel data are preferably read out in an at least partly compressed state from the divided image data corresponding to the readout phases with respect to each of the image recording dot forming elements.

If an inter-readout pitch of the readout positions for the pixel data is an integral multiple of the pixel data, the divided image data should preferably be divided into pixel data sequences perpendicular to the scanning direction.

If an inter-readout pitch of the readout positions for the pixel data is a rational multiple of the pixel pitch, in the divided image data generating step, the divided image data are generated in phase with respective recording dot forming positions in the scanning direction of the image recording dot forming elements from resolution-converted image data whose pixel pitch has been converted into a high resolution by which the inter-readout pitch is divisible, and are stored in the storage means.

According to the present invention, if an inter-readout pitch is not an integral multiple of the pixel data, but a rational multiple of the pixel data, the divided image data in phase with the respective image forming positions in the scanning direction of the image recording dot forming elements are generated from resolution-converted image data which are produced by converting the resolution of the pixel pitch into a resolution to produce divided image data such that the inter-readout pitch is exactly divisible, and are stored in the storage means. Consequently, the divided image data at successive memory addresses are obtained.

If the pixel pitch is rational P times the inter-readout pitch, the number of different readout phases of the image recording dot forming elements is represented by the numerator R of an irreducible fraction P=R/Q representing the rational P, and the divided image data of an Nth (N=0, 1, . . . , Q−1) phase are generated by reading out pixel data in a sequence determined by an integer part of P×i (i=0, 1, . . . )+N/Q from the image data with respect to each of the image recording dot forming elements of the different readout phases. The divided image data at successive memory addresses can similarly be obtained.

If pixel data are added to or deleted from the image data to correct the length of the image to be formed on the image recording surface, corresponding pixel data are added to or deleted from the divided image data, and the divided image data are reassigned to each of the image recording dot forming elements to allow the successive memory addresses of the storage means to be continuously accessed and read subsequently to the added or deleted pixel data in the scanning direction. Therefore, even if the image is corrected for length, the divided image data at successive memory addresses of the storage means can continuously be read.

The method may further comprise, after the divided image data generating step, a length correction reading out step of, if pixel data are read out from the storage means which stores the divided image data to correct the length of the image to be formed on the image recording surface, reading out the pixel data by skipping or repeating memory addresses which store pixel data for deleting or adding image recording dots. The image can thus be corrected for length without reassigning the divided image data.

According to the present invention, an image recording apparatus for relatively moving image recording dot forming elements in a normal scanning direction on an image recording surface at a predetermined feed pitch based on image data comprising pixel data for forming an image so as to form an intermittent sequence of image recording dots on the image recording surface, and relatively moving image recording dot forming elements in a reverse scanning direction which is opposite to the normal scanning direction at the predetermined feed pitch so as to form an intermittent sequence of image recording dots on the image recording surface to fill up the intermittent sequence of image recording dots, thereby forming an image made up of a successive sequence of image recording dots on the image recording surface, comprises storage means for storing the image data as divided image data if a resolution of the image formed on the image recording surface and the predetermined feed pitch are different from each other, wherein the divided image data divided such that they are in phase with recording dot forming positions in the normal scanning direction and the reverse scanning direction of the image recording dot forming elements, and the normal scanning direction and a direction of successive memory addresses are aligned with each other, and the reverse scanning direction and the direction of successive memory addresses are aligned with each other.

According to the present invention, when the image recording dot forming elements are relatively moved reciprocatingly over the image recording surface to form an image made up of a sequence of successive image recording dots on the image recording surface, the image data are stored in the storage means as the divided image data in phase with recording dot forming positions in the normal scanning direction and the reverse scanning direction of the image recording dot forming elements, wherein in the divided image data, the normal scanning direction and the direction of successive memory addresses being aligned with each other, and the reverse scanning direction and the direction of successive memory addresses being aligned with each other. Accordingly, the image data can successively be accessed and read out by memory reading means at a high speed (in a short time).

According to the present invention, a method of generating image data for use in relatively moving image recording dot forming elements in a normal scanning direction on an image recording surface at a predetermined feed pitch based on image data comprising pixel data for forming an image so as to form an intermittent sequence of image recording dots on the image recording surface, and relatively moving image recording dot forming elements in a reverse scanning direction which is opposite to the normal scanning direction at the predetermined feed pitch, thereby to form an intermittent sequence of image recording dots on the image recording surface to fill up the intermittent sequence of image recording dots, thereby forming an image made up of a successive sequence of image recording dots on the image recording surface, comprises a divided image data generating step of storing, in a storage means, the image data as divided image data if a resolution of the image formed on the image recording surface and the feed pitch are different from each other, the divided image data comprising divided image data such that they are in phase with respective recording dot forming positions in the normal scanning direction and the reverse scanning direction of the image recording dot forming elements, and the normal scanning direction and a direction of successive memory addresses are aligned with each other, and the reverse scanning direction and the direction of successive memory addresses are aligned with each other.

According to the present invention, when the image recording dot forming elements are relatively moved reciprocatingly over the image recording surface to form an image made up of a sequence of successive image recording dots on the image recording surface, the image data are stored in the storage means as the divided image data in phase with respective recording dot forming positions in the normal scanning direction and the reverse scanning direction of the image recording dot forming elements, with the normal scanning direction and the direction of successive memory addresses being aligned with each other, and the reverse scanning direction and the direction of successive memory addresses being aligned with each other. Accordingly, the image data can successively accessed and read out by memory reading means at a high speed (in a short time).

In the above invention, the image recording dot forming elements include an ink jet recording head or the like in addition to a DMD having micromirrors, and the image recording apparatus for moving the image recording dot forming elements reciprocatingly over the image recording surface includes a one-beam scanning exposure apparatus.

According to the present invention, even if the pixel pitch and the inter-readout pitch of the image recording dot forming elements are different from each other, the memory reading means can read out data from the image data at a high speed (in a short time).

According to the present invention, even if the pixel pitch and the inter-readout pitch of the image recording dot forming elements are different from each other, and pixel data are added to or deleted from the image data, the memory reading means can read out data from the image data at a high speed (in a short time).

The above and other objects, features, and advantages will become more apparent from the following description of preferred embodiments when taken in conjunction with the accompanying drawings.

### BRIEF DESCRIPTION OF THE DRAWINGS

FIG. 1 is a perspective view showing a general structure of an exposure apparatus using first through third embodiments of an image recording apparatus and a method of generating image data according to the present invention;

FIG. 2 is a perspective view showing a structure of a scanner of the exposure apparatus shown in FIG. 1;

FIG. 3A is a plan view showing an exposed region formed on the exposure surface of a substrate;

FIG. 3B is a plan view showing an array of exposed areas produced by exposure heads;

FIG. 4 is a view showing a DMD of an exposure head shown in FIG. 1;

FIG. 5 is a block diagram showing an arrangement of an electric control system of the exposure apparatus according to the first through third embodiments of the present invention;

FIG. 6A is a diagram illustrative of mirror data;

FIG. 6B is a diagram illustrative of frame data;

FIG. 7 is a view showing the relationship between the resolution of image data and feed pitches of mirrors of the DMD;

FIG. 8A is a diagram illustrative of image data to be divided;

FIG. 8B is a diagram illustrative of divided image data;

FIG. 8C is a diagram illustrative of mirror data;

FIG. 9 is a schematic diagram showing the relationship between reference marks on a substrate having an ideal shape and passage position information of a certain micromirror;

FIG. 10 is a diagram illustrative of a process of acquiring the exposure trajectory information of a micromirror;

FIG. 11 is a diagram illustrative of a process of acquiring the exposure trajectory information of a micromirror;

FIG. 12 is a diagram illustrative of a process of acquiring mirror data based on the exposure trajectory information of a micromirror;

FIG. 13 is a diagram showing an area within a thick frame in FIG. 12;

FIG. 14 is a diagram illustrative of a process of acquiring mirror data based on the exposure trajectory information of a micromirror;

FIG. 15 is a diagram illustrative of shifts of a direction in which a moving stage moves;

FIG. 16 is a diagram illustrative of the exposure trajectories of certain micromirrors;

FIG. 17 is a diagram illustrative of a process of acquiring mirror data based on the exposure trajectory information of micromirrors;

FIG. 18 is a diagram showing an area within a thick frame in FIG. 17;

FIG. 19 is a diagram illustrative of a process of acquiring the exposure trajectory information of micromirrors;

FIG. 20 is a diagram illustrative of mirror data;

FIG. 21 is a diagram illustrative of frame data;

FIG. 22 is a diagram showing the relationship of the exposure trajectory information of mirrors to one scanning line of image data;

FIG. 23 is a diagram illustrative of mirror data generated by referring to the exposure trajectory information shown in FIG. 22;

FIG. 24 is a diagram showing the relationship of the exposure trajectory information of mirrors to resolution-converted image data that are produced when the resolution of the image data shown in FIG. 22 is converted into a resolution that is five times higher;

FIG. 25 is a diagram illustrative of divided image data generated by dividing a rational multiple of the image data with respect to nine types of phase patterns from the resolution-converted image data shown in FIG. 24;

FIG. 26 is a diagram illustrative of how a substrate is expanded and contracted in a scanning direction;

FIG. 27 is a diagram illustrative of a process of acquiring mirror data depending on the expansion or contraction of the substrate;

FIG. 28 is a diagram showing the relationship of image data to be corrected for length and the phase of exposure trajectory information;

FIG. 29 is a diagram showing the relationship of image data corrected for length by inserting a pixel and the phase of the exposure trajectory information;

FIG. 30 is a diagram showing the relationship of image data corrected for length by deleting a pixel and the phase of the exposure trajectory information;

FIG. 31 is a diagram showing the relationship of image data to be corrected for length and the phase of exposure trajectory information;

FIG. 32 is a diagram showing the relationship of image data corrected for length by inserting a pixel at two locations and the phase of the exposure trajectory information;

FIG. 33 is a diagram showing the relationship of image data corrected for length by deleting a pixel from two locations and the phase of the exposure trajectory information;

FIG. 34 is a diagram illustrative of divided image data to be corrected for length;

FIG. 35A is a diagram illustrative of a process of reading out divided image data corrected for length by inserting a pixel at two locations;

FIG. 35B is a diagram illustrative of the divided image data which have been read out;

FIG. 36A is a diagram illustrative of a process of reading out divided image data corrected for length by deleting a pixel at two locations;

FIG. 36B is a diagram illustrative of the divided image data which have been read out;

FIG. 37 is a perspective view of a one-beam scanning exposure apparatus used to replace the scanner of the exposure apparatus shown in FIG. 1;

FIG. 38 is a diagram illustrative of the formation of a sequence of image recording dots made of even-numbered pixels and odd-numbered pixels on a scanning line according to reciprocating scanning;

FIG. 39 is a diagram illustrative of a multiple exposure based on a plurality of micromirrors;

FIG. 40 is a diagram illustrative of divided image data generated by dividing a rational multiple of image data with respect to types of phase patterns;

FIG. 41A is a diagram illustrative of divided image data grouped according to phase;

FIG. 41B is a diagram illustrative of divided image data grouped according to phase-divided line;

FIG. 41C is a diagram illustrative of divided image data comprising an alternate array of data of segment-divided phases; and

FIG. 42 is a view showing the relationship between the resolution of image data and feed pitches of mirrors of the DMD.

### BEST MODE FOR CARRYING OUT THE INVENTION

Exposure apparatus using embodiments of an image recording apparatus and a method of generating image data according to the present invention will be described in detail below with reference to the drawings.

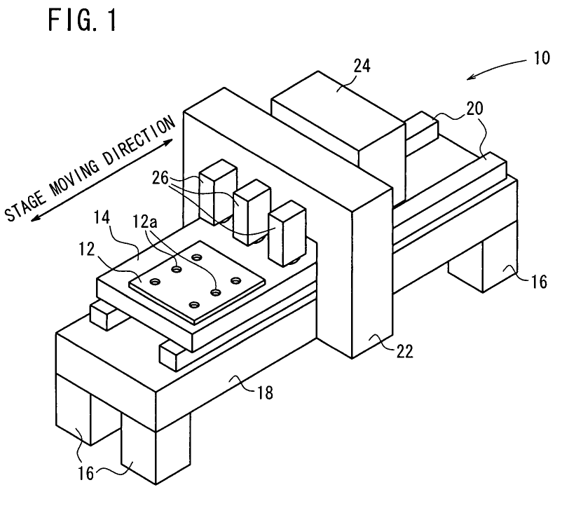

FIG. 1 is a perspective view showing a general structure of an exposure apparatus 10 according to first through third embodiments of the present invention. The exposure apparatus 10 is an apparatus for exposing a substrate 12 of a multilayer printed-wiring board to wiring patterns on respective layers.

The exposure apparatus 10 includes a moving stage 14 in the form of a flat plate for attracting and holding, to its surface, a substrate 12 having an image recording surface. A mount base 18 in the form of a thick plate supported on four legs 16 supports on its upper surface two guides 20 extending along a stage moving direction. The moving stage 14 has its longitudinal direction aligned with the stage moving direction, and is reciprocally movably supported by the guides 20.

A channel-shaped gate 22 is mounted centrally on the mount base 18 astride the moving path of the moving stage 14. The channel-shaped gate 22 has ends fixed respectively to opposite side surfaces of the mount base 18. A scanner 24 is disposed on one side of the gate 22, and a plurality of cameras 26 are mounted on the other side of the gate 22 for detecting the leading and trailing ends of substrate 12 and the positions of a plurality of circular reference marks 12a disposed in advance on the substrate 12.

The reference marks 12a on the substrate 12 comprise holes, for example, formed in the substrate 12 based on preset reference mark position information. Lands, vias, or etching marks may be used instead of the holes. A prescribed pattern formed on the substrate 12, e.g., a pattern on a layer lower than the layer to be exposed, may be used as the reference marks 12a. In FIG. 1, only the six reference marks 12a are shown. Actually, however, a number of reference marks 12a are provided on the substrate 12. Since the reference marks 12a represent reference positions for use in alignment correction to be described later, they may be replaced with sides or corners of the substrate 12.

The scanner 24 and the cameras 26 are mounted on the gate 22 and fixedly disposed above the moving path of the moving stage 14. The scanner 24 and the cameras 26 are connected to a controller 70 to be described later which controls them.

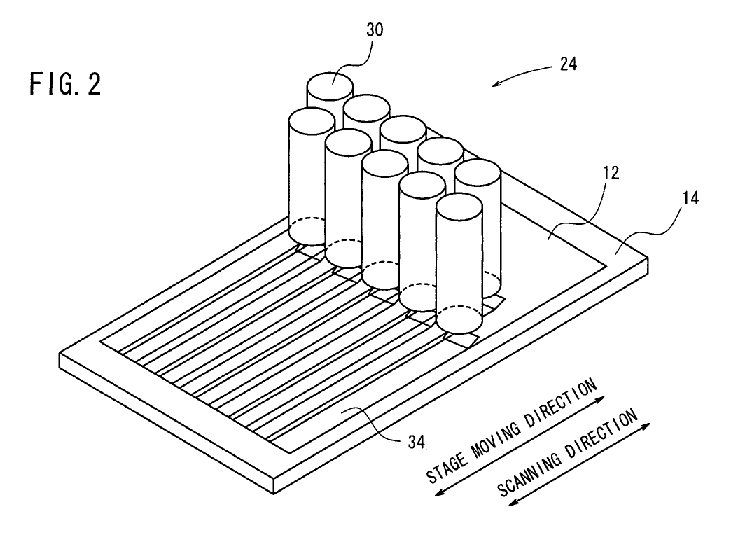

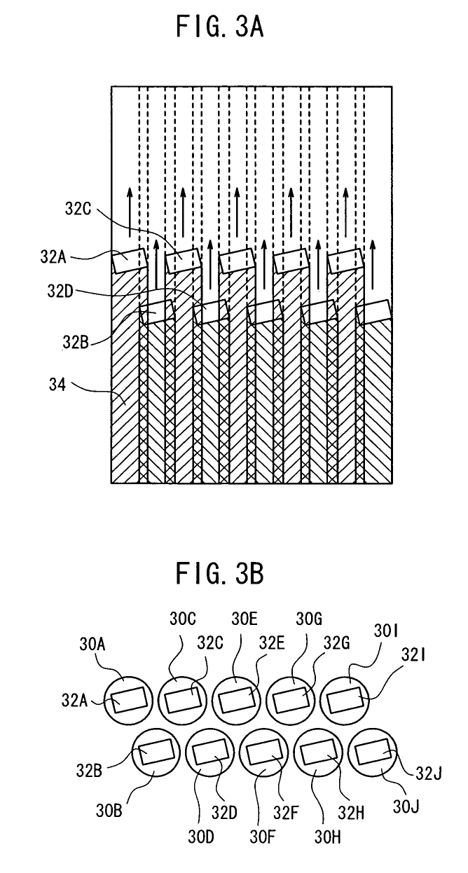

As shown in FIGS. 2 and 3B, the scanner 24 has ten exposure heads 30 (30A through 30J) arranged substantially in a matrix of two rows and five columns.

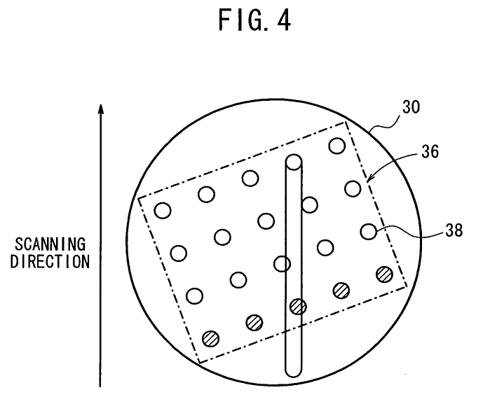

As shown in FIG. 4, each of the exposure heads 30 houses therein a digital micromirror device (DMD) 36 which is a spatial light modulator (SLM) for spatially modulating a light beam applied thereto. The DMD 36 comprises a number of micromirrors 38 arrayed two-dimensionally in rows and columns which are perpendicular to each other. The columns of the micromirrors 38 are inclined at a preset angle θ to a scanning direction. Each of the exposure heads 30 has an exposure area 32 (32A through 32J: see FIG. 3B) which comprises a rectangular area inclined to the scanning direction. As the moving stage 14 moves, a band-shaped exposed region 34 as shown in FIG. 3A is formed on the substrate 12 by each of the exposure heads 30. A light source for applying a light beam to each of the exposure heads 30, which is omitted from illustration, may comprise a laser beam source or the like.

The micromirrors 38 of the DMD 36 disposed in each of the exposure heads 30 are individually turned on and off to expose the substrate 12 to a dot pattern corresponding to the micromirrors 38 of the DMD 36 (a dot is formed when a micromirror 38 is turned on and not formed when it is turned off). The band-shaped exposed region 34 is formed by a two-dimensional array of dots corresponding to the micromirrors 38 shown in FIG. 4. The dot pattern in the shape of the two-dimensional array of dots is inclined to the scanning direction, so that the dots arranged in the scanning direction pass between the dots arranged in a direction crossing the scanning direction for a higher resolution. Due to variations of adjustment of the tilt angle, there are some dots that are not used. In FIG. 4, for example, the dots that are shown hatched are not used, and the micromirrors 38 of the DMD 36 which correspond to those dots remain turned off at all times.

As shown in FIGS. 3A and 3B, the exposure heads 30 arrayed linearly in the rows are displaced from each other by a given distance in the arrayed direction such that each of the band-shaped exposed regions 34 overlaps the adjacent band-shaped exposed regions 34. Therefore, a region which is not exposed between the exposure area 32A that is positioned at the leftmost end of the first row and the exposure area 32C that is positioned immediate right of the exposure area 32A is exposed by the exposure area 32B that is positioned at the leftmost end of the second row. Similarly, a region which is not exposed between the exposure area 32B and the exposure area 32D that is positioned immediate right of the exposure area 32B is exposed by the exposure area 32C.

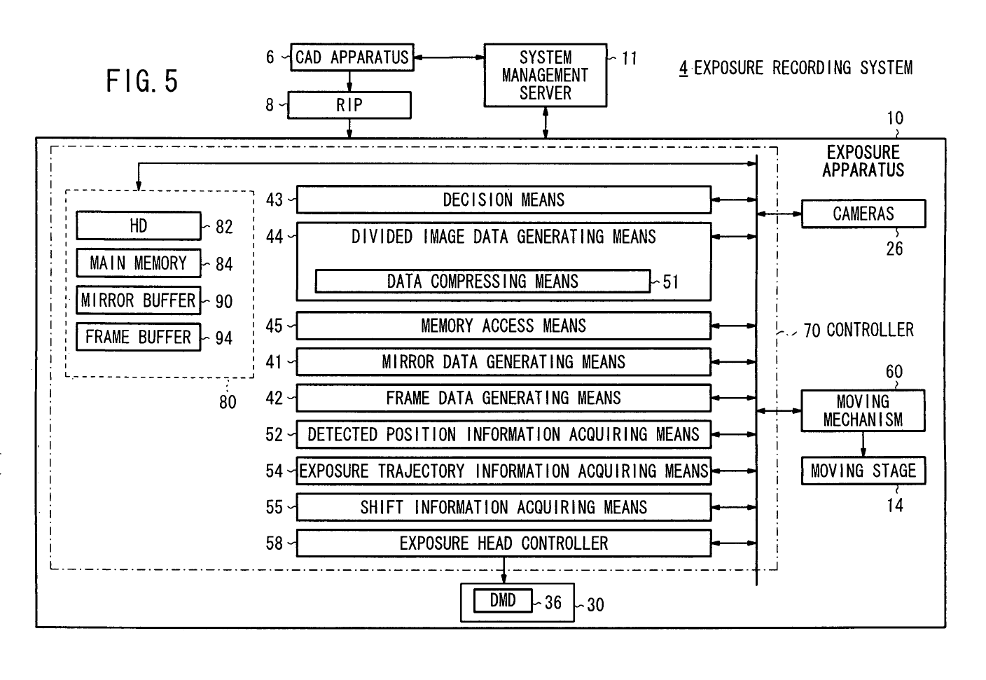

An electric arrangement of an exposure recording system 4 including the exposure apparatus 10 will be described below with reference to FIG. 5.

The exposure recording system 4 basically comprises a CAD apparatus (CAD server) 6 for generating image data representing a wiring pattern to which a substrate is to be exposed and outputting the image data as vector data, a raster image processor (RIP) 8 for converting the vector data transferred from the CAD apparatus 6 into bitmap data and outputting the bitmap data, and the exposure apparatus 10 which includes the controller 70 for temporarily storing the image data transferred from the RIP 8 and converting the image data into image data that can conveniently be handled by the DMDs 36.

The controller 70 whose internal arrangement is schematically illustrated comprises a computer including a CPU, not shown, and a storage means 80 including a hard disk 82, a main memory 84, a mirror data temporary storage buffer (hereinafter referred to as a mirror buffer) 90, and a frame data temporary storage buffer (hereinafter referred to as a frame buffer) 94. When the CPU executes programs stored in the hard disk 82, the CPU operates as various functional means, to be described later, such as a divided image data generating means 44, etc.

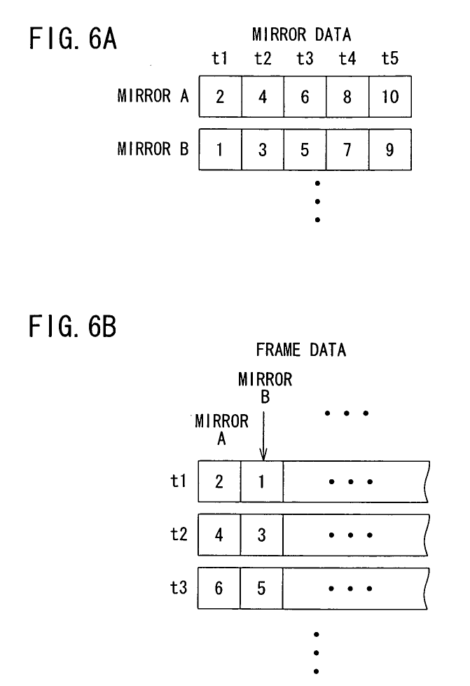

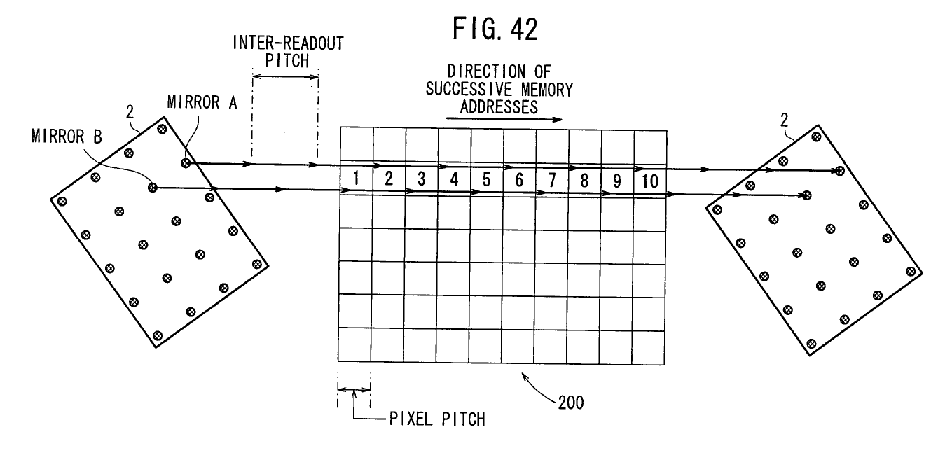

Mirror data, as described with respect to the image data 200 shown in FIG. 42, refer, as shown in FIG. 6A, to data (data per mirror) generated for respective mirrors along respective trajectories (which may be regarded as trajectories of mirror images (image recording dot forming elements)) of exposure points (image recording dots) produced on the substrate 12 by mirrors A, B, . . . of the DMD 36.

As shown in FIG. 6B, frame data refer to mirror data grouped according to exposure times t1, t2, . . . of the DMD 36 and produced when the mirror data are converted in the same manner as with the transposition in matrix.

As described later, for exposing the substrate 12 with the DMDs 36, mirror data are generated based on image data, and frame data are generated from the mirror data.

As indicated by the schematic arrangement of the controller 70 shown in FIG. 5, the functions that are achieved by the CPU include a detected position information acquiring means 52 for acquiring detected position information of the reference marks 12a based on images of the reference marks 12a which are captured by the cameras 26, a shift information acquiring means 55 for acquiring shift information representing a shift of the moving stage 14 in a direction perpendicular to the stage moving direction (the scanning direction), an exposure trajectory information acquiring means 54 for acquiring information of the exposure trajectories of the respective micromirrors 38 on the substrate 12 in an actual exposure process based on the shift information acquired by the shift information acquiring means 55 and the detected position information acquired by the detected position information acquiring means 52, a mirror data generating means 41 for generating mirror data for the respective micromirrors 38 based on the exposure trajectory information of the respective micromirrors 38 which is acquired by the exposure trajectory information acquiring means 54 and the image data supplied from the RIP 8, frame data generating means 42 for generating frame data from the mirror data for the respective micromirrors 38 which is acquired by the mirror data generating means 41, a decision means 43 for determining whether or not a pixel pitch on the substrate 12 which is supplied from a system management server 11 and an inter-readout pitch for the micromirrors 38 are different from each other, a divided image data generating means 44 for storing the image data in phase with recording dot forming positions (image recording dots, exposure points) in the scanning direction of the respective micromirrors 38, as divided image data which have been divided in advance with the scanning direction and the direction of successive memory addresses being aligned with each other, in the main memory 84 or the hard disk 82 of the storage means, if the pixel pitch and the inter-readout pitch are judged as being different from each other, and a memory access means 45 for reading out data from and writing data in the storage means 80.

The exposure apparatus 10 also includes an exposure head controller 58 for controlling the exposure heads 30 to expose the substrate by the DMDs 36 of the exposure heads 30 based on the frame data generated by the frame data generating means 42, and a moving mechanism 60 for moving the moving stage 14 in the stage moving direction. The moving mechanism 60 may be of any known structures insofar as they can reciprocally move the moving stage 14 along the guides 20.

The exposure recording system 4 including the exposure apparatus 10 according to the first embodiment is basically constructed as described above. Operation of the exposure apparatus 10 will be described below.

The CAD apparatus 6 generates vector data representing a wiring pattern to which the substrate 12 is to be exposed. The CAD apparatus 6 inputs the vector data to the RIP 8, which converts the vector data into raster data. The raster data are stored in the hard disk 82 of the exposure apparatus 10 by the memory access means 45.

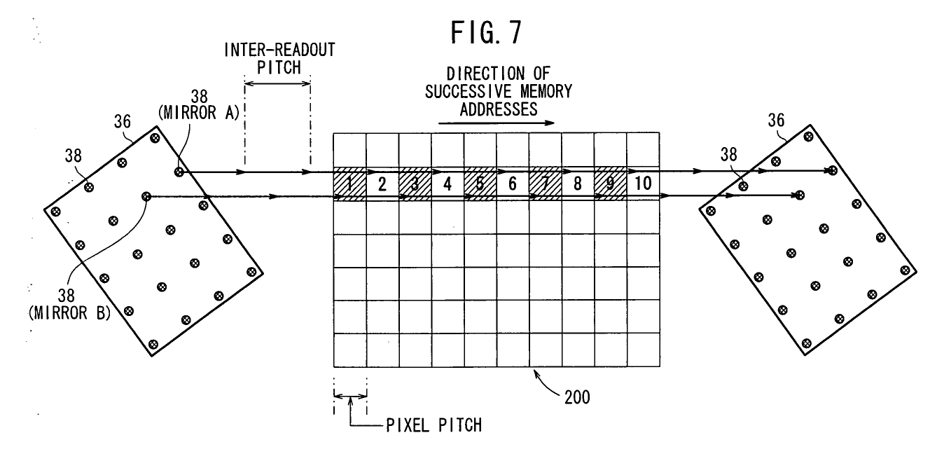

It is assumed that the raster data stored in the hard disk 82 represent the image data 200 made up of pixel data shown in FIG. 7 which is the same as FIG. 42.

When the image data 200 are stored in the hard disk 82, the decision means 43 determines whether or not a pixel pitch on the substrate 12 which is supplied from the system management server 11 and an inter-readout pitch are different from each other (decision step).

In the example shown in FIG. 7, it is assumed that the pixel pitch (here, the size of a pixel in the scanning direction) is 10 [μm] and the inter-readout pitch for the DMD 36 (the micromirrors 38) along the scanning direction of the substrate 12 is 20 [μm] which is twice, i.e., an integral multiple of, the pixel pitch. Therefore, the decision means 43 judges that the pixel pitch and the inter-readout pitch are different from each other.

When the decision means 43 judges that the pixel pitch and the inter-readout pitch are different from each other, the divided image data generating means 44 divides the image data 200 into divided image data while bringing them into phase with the recording dot forming positions (the positions of the tip ends of the arrows in FIG. 7) in the scanning direction of the micromirrors 38, i.e., the mirrors A, B for an easier understanding in the present embodiment, and aligning the scanning direction with the direction of successive memory addresses, and stores the divided image data in the hard disk 82 or the main memory 84 using the memory access means 45 (divided image data generating step).

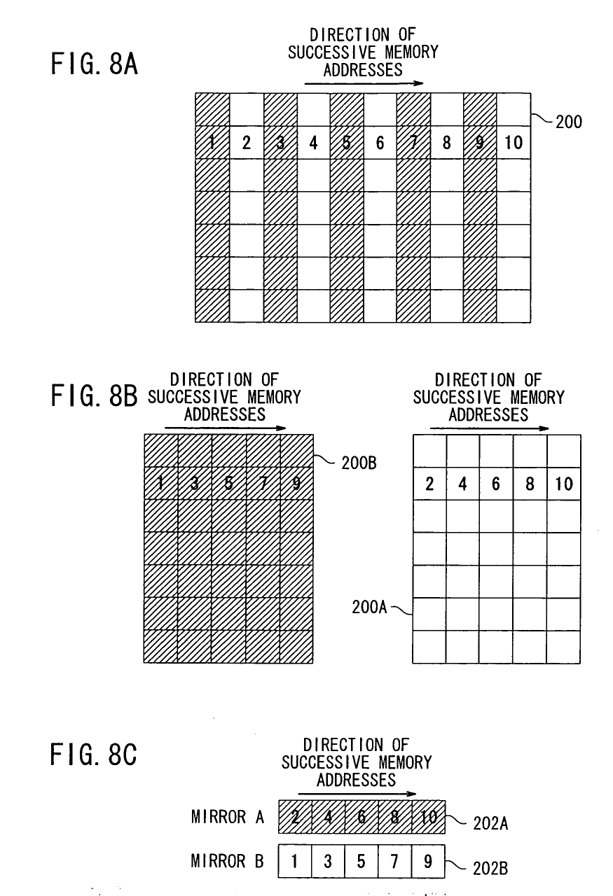

Specifically, as shown in FIG. 8B, the divided image data generating means 44 divides the image data 200 shown in FIG. 8A into divided image data 200A for micromirrors 38 which uses the pixel data of the sequence of pixels “2, 4, 6, 8, 10” which is the same as the mirror A and divided image data 200B for micromirrors 38 which uses the pixel data of the sequence of pixels “1, 3, 5, 7, 9” (shown hatched) which is the same as the mirror B that is a ½ inter-readout pitch different from the mirror A, and temporarily stores the divided image data 200A, 200B in the hard disk 82 or the main memory 84 at positions of successive memory addresses thereof.

When the divided image data 200A, 200B are stored in the hard disk 82 or the main memory 84, the controller 70 which controls operation of the exposure apparatus 10 in its entirety outputs a control signal. In response to the control signal, the moving mechanism 60 moves the moving stage 14 from the position shown in FIG. 1 along the guides 20 to a predetermined initial position on an upstream side, and thereafter moves the moving stage 14 to a downstream side at a desired speed.

The upstream side refers to a right-hand side in FIG. 1, i.e., a side of the gate 22 where the scanner 24 is installed, and the downstream side refers to a left-hand side in FIG. 1, i.e., a side of the gate 22 where the cameras 26 are installed.

When the substrate 12 on the moving stage 14 passes below the cameras 26 as the moving stage 14 moves as mentioned-above, the cameras 26 capture images of the substrate 12 and supply captured image data representing the captured images to the detected position information acquiring means 52.

Based on the supplied captured image data, the detected position information acquiring means 52 acquires detected position information indicating the positions of the reference marks 12a on the substrate 12. The detected position information of the reference marks 12a may be acquired by extracting cylindrical images or may be acquired by any other known acquisition methods. Specifically, the detected position information of the reference marks 12a is acquired as coordinate values. The origin for those coordinate values may be provided by one of the four corners of the captured image data of the substrate 12, or by a preset position in the captured image data, or by the position of one of the reference marks 12a. In the present embodiment, the cameras 26 and the detected position information acquiring means 52 jointly make up a positional information detecting means.

The detected position information of the reference marks 12a thus acquired is output from the detected position information acquiring means 52 to the exposure trajectory information acquiring means 54.

Based on the supplied detected position information, the exposure trajectory information acquiring means 54 acquires information of the exposure trajectories of the respective micromirrors 38 on the substrate 12 in an actual exposure process. Specifically, the exposure trajectory information acquiring means 54 has preset therein passage position information representing the positions where the images of the micromirrors 38 of the DMD 36 of each of the exposure heads 30, with respect to the respective micromirrors 38. The passage position information has preset by the installed positions of the exposure heads 30 with respect to the installed position of the substrate 12 on the moving stage 14, and is represented by vectors or a plurality of coordinate values using the same origin as the reference mark position information and the detected position information. The passage position information may be determined by forming a “<”-shaped slit in a flat surface flush with the moving stage 14, providing an area image sensor for detecting beams passing through the slit, and detecting the beam positions with the area image sensor.

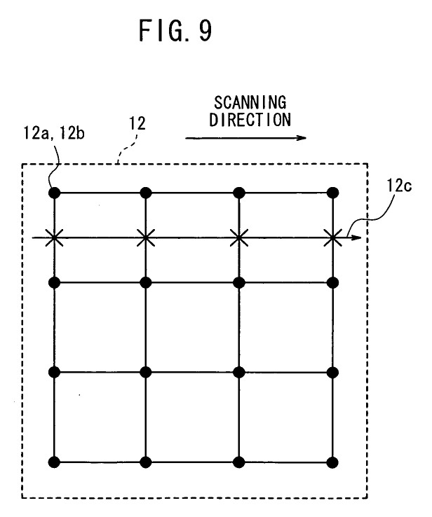

FIG. 9 is a schematic diagram showing the relationship between a substrate 12 having an ideal shape which has not been processed by a pressing process, etc., i.e., a substrate 12 which is free of deformations such as distortions and has reference marks 12a disposed in the positions represented by preset reference mark position information 12b, and passage position information 12c of a certain micromirror 38.

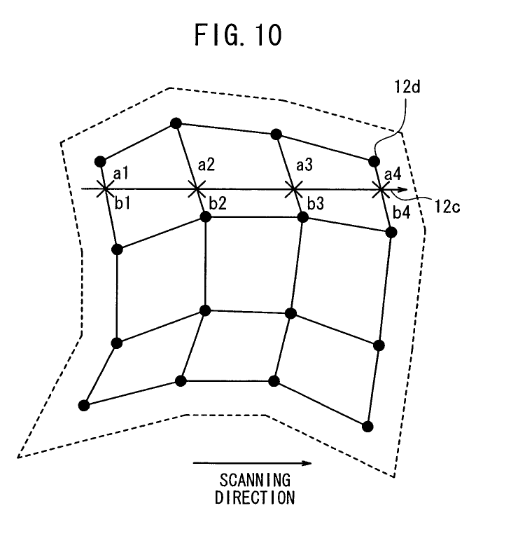

As shown in FIG. 10, the exposure trajectory information acquiring means 54 determines the coordinate values of crossing points between straight lines which interconnect detected position information 12d that are adjacent to each other in directions perpendicular to the scanning direction and straight line representing the passage position information 12c of the micromirror 38. In other words, the exposure trajectory information acquiring means 54 determines the coordinate value of point marked with x, determines distances between the point marked with x and the detected position information 12d that are adjacent to the point marked with x in the perpendicular direction, and determines the ratio of the distances between one of the adjacent detected position information 12d and the point marked with x and the distance between the other of the adjacent detected position information 12d and the point marked with x. Specifically, the ratios of a1:b1, a2:b2, a3:b3, and a4:b4 shown in FIG. 10 are determined as exposure trajectory information. The ratios thus determined represent an exposure trajectory (recording dot forming trajectory) of the micromirror 38 on the substrate 12 which has been deformed, i.e., an exposure trajectory of the micromirror 38 in an actual exposure process.

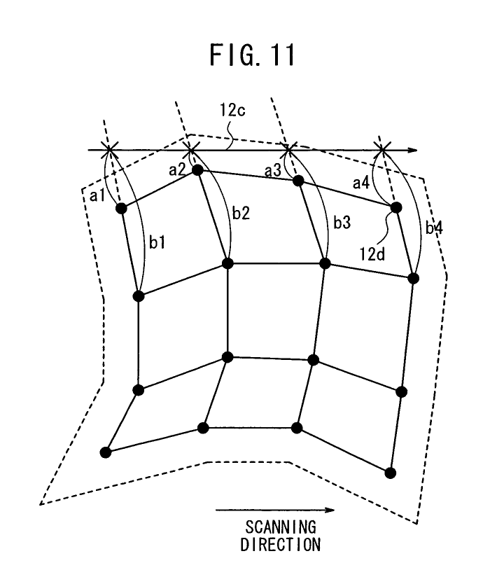

If the passage position information 12c is positioned outside of a range surrounded by the detected position information 12d as shown in FIG. 11, then the ratios are determined by external division as shown in FIG. 11.

The exposure trajectory information determined with respect to the respective micromirrors 38 are input to the mirror data generating means 41.

Based on the input exposure trajectory information, the mirror data generating means 41 acquires mirror data for the micromirrors 38 from the divided image data. 200A or the divided image data 200B through the memory access means 45, and stores the mirror data in the mirror buffer 90.

As shown in FIG. 8C, mirror data 202A for the mirror A can be stored in the mirror buffer 90 by specifying successive addresses of the divided image data 200A, and mirror data 202B for the mirror B can be stored in the mirror buffer 90 by specifying successive addresses of the divided image data 200B.

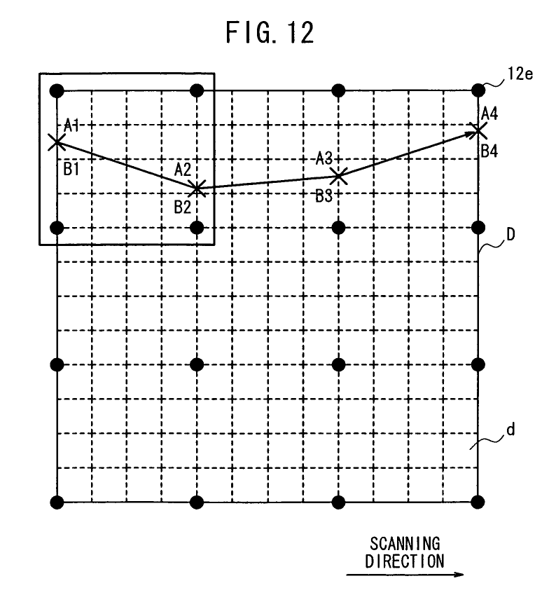

More specifically, as shown in FIG. 12, image data D (image data schematically representing the divided image data 200A and the divided image data 200B) are associated with exposure image data reference position information 12e disposed at positions corresponding to the positions indicated by the reference mark position information 12b, and the coordinate values of points by which straight lines interconnecting the exposure image data reference position information 12e adjacent to each other in the direction perpendicular to the scanning direction are divided based on the ratios represented by the exposure trajectory information, are determined. In other words, the coordinate values of points which satisfy the following equations are determined:

a1:b1=A1:B1

a2:b2=A2:B2

a3:b3=A3:B3

a4:b4=A4:B4

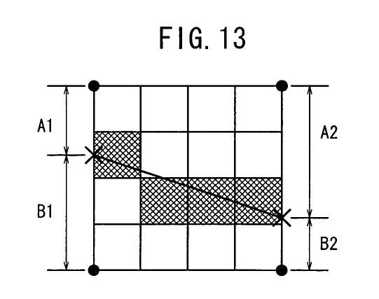

Pixel data d on a straight line interconnecting the points thus determined serve as mirror data actually corresponding to the exposure trajectory information of the micromirror 38. Therefore, the pixel data d at the points through which the above straight line passes on the exposure image data D are acquired as mirror data (corresponding to the mirror data 202A, 202B). Pixel data d refer to a minimum unit of data of the image data D. An extracted range surrounded by the thick line in FIG. 12 is illustrated in FIG. 13. Specifically, the pixel data shown hatched in FIG. 13 are acquired as mirror data. If the straight line interconnecting the dividing points based on the ratios indicated by the exposure trajectory information is not present on the exposure image data D, then mirror data on the straight line are acquired as nil.

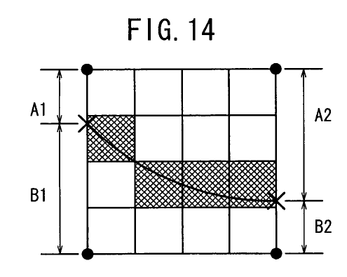

The dividing points based on the ratios indicated by the exposure trajectory information may be interconnected by a straight line, and pixel data on the straight line may be acquired as mirror data. Alternatively, as shown in FIG. 14, the above points may be interconnected by a curved line by spline interpolation or the like, and pixel data on the curved line may be acquired as mirror data.

If the points are interconnected by a curved line by spline interpolation or the like, then it is possible to acquire exposure point data that are more representative of the deformation of the substrate 12 can be acquired. It is also possible to acquire mirror data that are more representative of the deformation of the substrate 12 if properties of the material of the substrate 12 (e.g., a property to expand or contract only in a certain direction) are reflected in the calculation method such as spline interpolation or the like.

The mirror data may contain shift information of the moving trajectory of the moving stage 14 in addition to the deformation of the substrate 12.

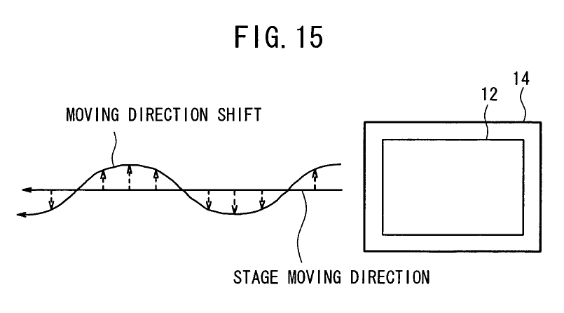

Specifically, the shift information acquiring means 55 acquires shift information of the moving stage 14. As shown in FIG. 15, the shift information represents a shift of the actual moving direction of the moving stage 14 with respect to a preset stage moving direction. Specifically, as shown in FIG. 15, a shift of the actual moving trajectory of the moving stage 14 is acquired at predetermined intervals in the direction perpendicular to the preset stage moving direction, with respect to the moving trajectory in the preset stage moving direction, the orientation and length of each dotted-line arrow in FIG. 15 represents such a shift.

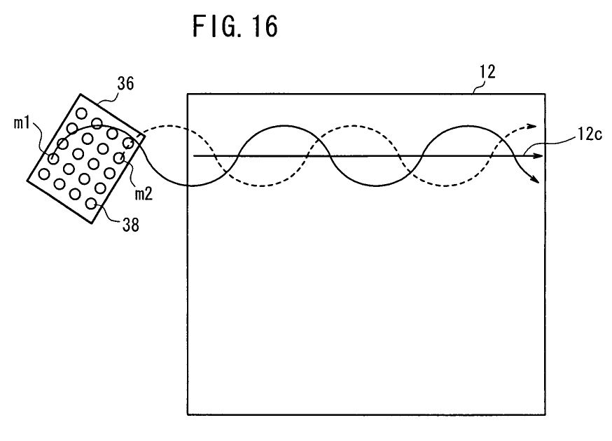

If the moving trajectory of the moving stage 14 suffers a shift as described above, then the actual exposure trajectory on the substrate 12 of each of the micromirrors 38 upon exposure is shifted depending on the above shift with respect to the preset passage position information 12c of each micromirror 38, as shown in FIG. 16. Therefore, it is necessary to acquire mirror data depending on the actual exposure trajectory of each micromirror 38. As shown in FIG. 16, although a micromirror m1 and a micromirror m2 are supposed to pass through the same position on the substrate 12, their actual exposure trajectories are brought out of phase with each other if the moving trajectory of the moving stage 14 suffers a shift. Accordingly, it is necessary to acquire mirror data in view of such a phase shift.

In the exposure apparatus 10, mirror data depending on a shift of the exposure trajectory of each micromirror 28 is acquired. Specifically, a shift of the moving stage 14 is measured in advance, and the measured shift is acquired by the shift information acquiring means 55 as described above.

The shift information acquiring means 55 outputs the acquired shift to the exposure trajectory information acquiring means 54. The shift may be measured by a measuring method using a laser beam which is carried out by an IC wafer stepper apparatus or the like. For example, a reflecting surface extending in the stage moving direction is provided on the moving stage 14, and a laser beam source for emitting a laser beam toward the reflecting surface and a detector for detecting a reflected beam from the reflecting surface are also provided. As the moving stage 14 moves, the detector successively detects phase shifts of the reflected beam for thereby measuring the above shift.

The passage position information 12c of each micromirror 38 is set in the exposure trajectory information acquiring means 54. Based on the input shift and the passage position information 12c of each micromirror 38, the exposure trajectory information acquiring means 54 acquires exposure trajectory information representing an actual exposure trajectory on the substrate 12 of each micromirror 38 upon exposure. The passage position information 12c shown in FIG. 16 is the same as the passage position information 12c described above with reference to FIGS. 9 through 11.

The exposure trajectory information acquiring means 54 then outputs the exposure trajectory information of each micromirror 38 to the mirror data generating means 41. The mirror data generating means 41 acquires mirror data corresponding to the exposure trajectory information of each micromirror 38 from the temporarily stored exposure image data D.

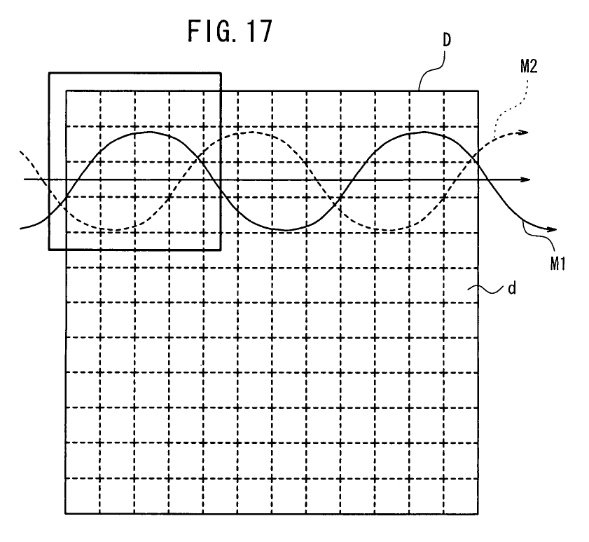

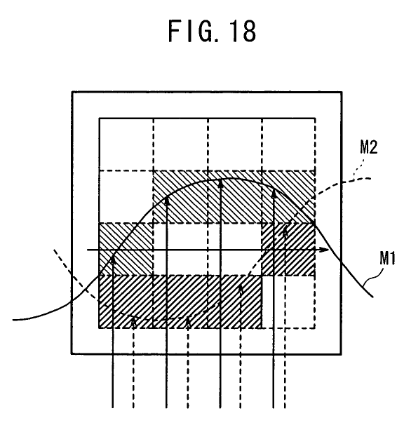

Specifically, mirror data placed on exposure trajectory information M1, M2 indicated by curved lines in the exposure image data D shown in FIG. 17 are acquired. An extracted range surrounded by the thick line in FIG. 17 is illustrated in FIG. 18. Specifically, pixel data shown hatched in FIG. 18 are acquired as exposure point data. The exposure trajectory information M1 shown in FIG. 17 represents exposure trajectory information of the micromirror m1 shown in FIG. 16, and the exposure trajectory information M2 shown in FIG. 17 represents exposure trajectory information of the micromirror m2 shown in FIG. 16. The exposure image data D are held in relatively positional relationship to the passage position information 12c, and the origin serving as a reference for the placement of each pixel data d of the exposure image data D is aligned with the origin of the passage position information 12c.

In the exposure apparatus 10, the detected position information of the reference marks 12a which has been acquired by the detected position information acquiring means 52 and the shift information acquired as described above by the shift information acquiring means 55 are input to the exposure trajectory information acquiring means 54.

Based on the detected position information and the shift information which have been input, the exposure trajectory information acquiring means 54 acquires exposure trajectory information representing actual exposure trajectories on the substrate 12 of the respective micromirrors 38 upon exposure.

Specifically, as described above with reference to FIGS. 9 through 11, the exposure trajectory information acquiring means 54 determines the coordinate values of crossing points between straight lines which interconnect detected position information 12d adjacent to each other in the direction perpendicular to the scanning direction and straight line representing the passage position information 12c of the micromirror 38, determines distances between the crossing points and the detected position information 12d adjacent to the crossing points in the perpendicular direction, and determines a ratio of the distances between one of the adjacent detected position information 12d and the crossing point and the distance between the other of the adjacent detected position information 12d and the crossing point per crossing point.

Based on the input shift and the passage position information 12c of each micromirror 38, the exposure trajectory information acquiring means 54 acquires provisional exposure trajectory information on the substrate 12 of each micromirror 38, as indicated by the curve lines shown in FIG. 17.

The exposure trajectory information acquiring means 54 outputs the ratios and the provisional exposure trajectory information thus determined as exposure trajectory information to the mirror data generating means 41.

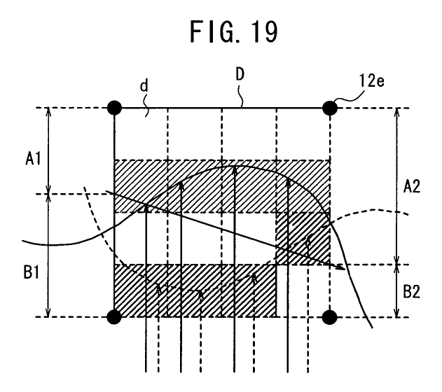

As shown in FIG. 19, the mirror data generating means 41 determines points at which straight lines interconnecting the exposure image data reference position information 12e adjacent to each other in the directions perpendicular to the scanning direction in the exposure image data D are divided based on the input ratios, thereafter determines a straight line interconnecting the points, determines curved lines representing exposure trajectory information by tilting the provisional exposure trajectory information through the angle of tilt of the straight line with respect to the scanning direction, and acquires pixel data d on the curved lines as exposure point data. Specifically, the pixel data shown hatched in FIG. 19 are acquired as exposure point data. In FIG. 19, A1:B1 and A2:B2 represent ratios which satisfy the relationship a1:b1=A1:B1, a2:b2=A2:B2 where a1:b1 and a2:b2 represent ratios supplied from the exposure trajectory information acquiring means 54.

The mirror data generating means 41 generates mirror data for the respective micromirrors 38, and stores the generated mirror data in the mirror buffer 90.

When the mirror data for the respective micromirrors 38 are stored in the mirror buffer 90, the moving stage 14 is moved again upstream at a desired speed.

When the leading end of the substrate 12 is detected by the cameras 26, the substrate 12 starts being exposed. Specifically, the exposure head controller 58 outputs control signals based on the mirror data to the DMDs 36 of the exposure heads 30. Based on the control signals, the exposure heads 30 turn on and off the micromirrors 38 of the DMDs 36 to expose the substrate 12.

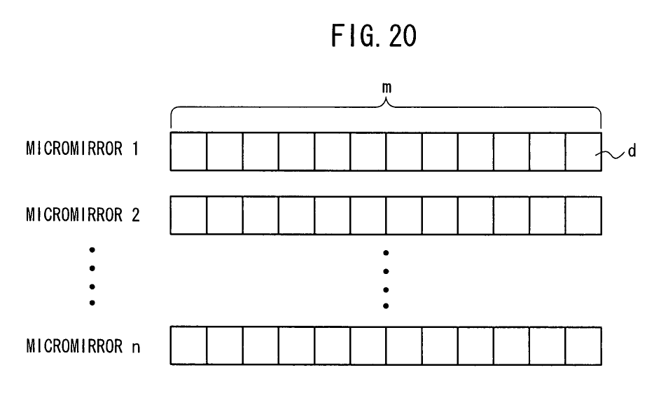

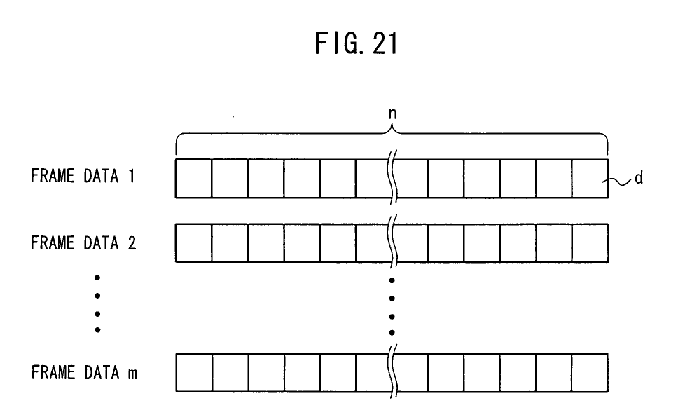

When the exposure head controller 58 outputs control signals to the exposure heads 30, the control signals as they correspond to the respective positions of the exposure heads 30 with respect to the substrate 12 are successively supplied from the exposure head controller 58 to the exposure heads 30 as the moving stage 14 moves. At this time, as shown in FIG. 20 (which illustrates the same mirror data as those shown in FIG. 6A), mirror data corresponding to the respective positions of the exposure heads 30 may be successively read, one by one, from the respective sequences of m mirror data acquired for the respective micromirrors 38, and output to the DMDs 36 of the exposure heads 30. In the present embodiment, the frame data generating means 42 rotates or transposes, using a matrix, the mirror data acquired as shown in FIG. 20, thereby generating frame data 1 through m corresponding to the respective positions of the exposure heads 30 with respect to the substrate 12, as shown in FIG. 21 (which illustrates the same frame data as those shown in FIG. 6B), and successively outputs the frame data 1 through m to the respective exposure heads 30.

As the moving stage 14 moves, the exposure head controller 58 outputs control signals to the exposure heads 30 to continuously expose the substrate 12. When the trailing end of the substrate 12 is detected by the cameras 26, the exposure process is put to an end.

According to the first embodiment, as described above, the exposure apparatus (image recording apparatus) 10 moves the images (image recording dot forming elements) of a plurality of micromirrors 38 relatively along the scanning direction on the substrate (image recording surface) 12 based on the image data 200 comprising pixel data for forming an image on the substrate 12, thereby to form a sequence of image recording dots on the substrate (image recording surface) 12 to record (form) by way of exposure an image on the substrate (image recording surface) 12. The exposure apparatus 10 includes the storage means 80 (the main memory 84 or the hard disk 82) for storing the image data 200 as divided image data 200A, 200B in case the pixel pitch (10 [μm]) on the substrate (image recording surface) 12 and the inter-readout pitch (20 [μm]) are different from each other.

The divided image data 200A, 200B are divided such that the image data 200 are in phase with the recording dot forming positions in the scanning direction of the respective micromirrors 38, with the scanning direction and the direction of successive memory addresses of the storage means 80 being aligned with each other.

Since the image data 200 comprising pixel data for forming an image are stored in the storage means 80 as the divided image data 200A, 200B divided in advance such that they are in phase with the recording dot forming positions in the scanning direction of the respective micromirrors 38, with the scanning direction and the direction of successive memory addresses being aligned with each other. Therefore, even if the pixel pitch and the inter-readout pitch for the micromirrors 38 are different from each other, the image data 200 can be read out at a high speed (in a short time) by reading out data from the divided image data 200A, 200B with the memory access means (memory reading out means) 45.

The correction for a misalignment (tilt correction) shown in FIGS. 12 through 19 can be performed in each of the divided image data 200A, 200B.

A second embodiment will be described below.

In the first embodiment described above, the inter-readout pitch for the micromirrors 38 is twice, i.e., an integral multiple of, the pixel pitch. If the inter-readout pitch is an integral multiple of the pixel pitch, then as it is twice the pixel pitch, the image data may be stored as divided image data that are divided at (1/integer) in the direction of successive memory addresses in the storage means 80, for high-speed data readout.

Even if the inter-readout pitch is a rational multiple (which should not be widely different, but should be close to, an integral multiple for minimizing hardware and software limitations) of the pixel pitch, the image data can be divided by phase division. Specifically, the image data can be divided by phase division if the inter-readout pitch can be divided without a remainder, by a higher resolution (a smaller pixel pitch produced by apparently dividing the pixel pitch) of the image data.

The second embodiment, which is based on the above concept, will be described in specific detail below.

For example, it is assumed that the pixel pitch is 0.5 [μm] and the inter-readout pitch is 0.9 [μm]. The inter-readout pitch is a rational multiple (0.9/0.5=9/5) of the pixel pitch.

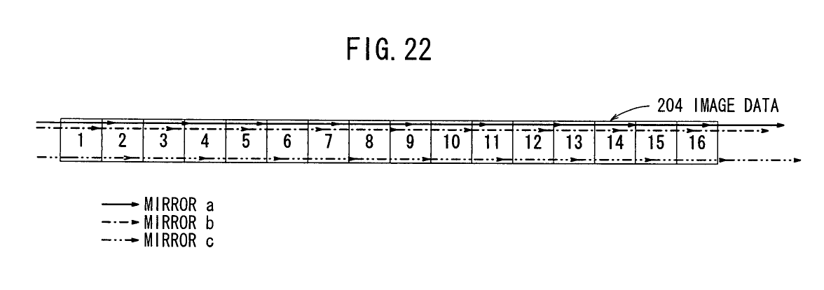

FIG. 22 shows the relationship of the exposure trajectory information of mirrors a, b, c to one scanning line of image data 204 comprising pixel data. Actually, the exposure trajectory information is obtained by the exposure trajectory information acquiring means 54.

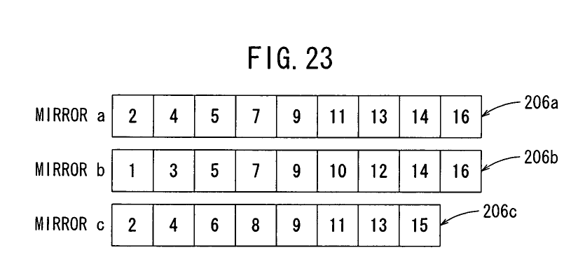

FIG. 23 is illustrative of mirror data 206a, 206b, 206c generated by the mirror data generating means 41 for the mirrors a, b, c by referring to the exposure trajectory information shown in FIG. 22.

The divided image data generating means 44 converts the resolution of the pixel pitch of 0.5 [μm] into a resolution (integral multiple resolution) representing a pixel pitch that is indicated by one-(integer)th of the pixel pitch of 0.5 [μm], with respect to the inter-readout pitch of 0.9 [μm]. In the present example, the resolution of the pixel pitch of 0.5 [μm] is converted into a resolution that is five times (integral multiple) higher, i.e., a resolution of 0.1 [μm] (a pixel pitch represented by a one-(integer)th of the pixel pitch of 0.5 [μm]). As the inter-readout pitch of 0.9 [μm] is divisible by the higher integral multiple resolution of 0.1 [μm] (0.9/0.1=9), the quotient 9 is used as the number of phase patterns.

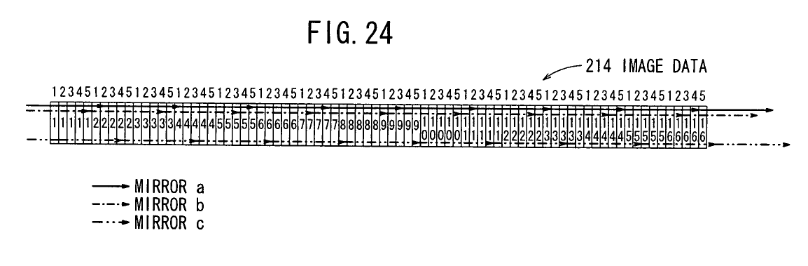

FIG. 24 shows resolution-converted image data 214 having a resolution of 0.1 [μm] which is converted from one scanning line of image data 204.

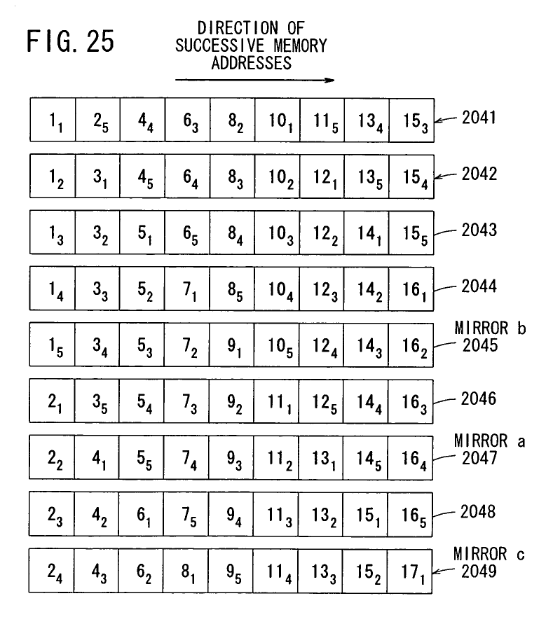

FIG. 25 shows divided image data 2041 through 2049 that are generated by the divided image data generating means 44 from the resolution-converted image data 214 shown in FIG. 24 depending on the nine phase patterns. By storing the divided image data 2041 through 2049 of the nine types in the direction of successive memory addresses in the hard disk 82 or the main memory 84, it is possible to obtain divided image data 2047, 2045, 2049 for the mirrors a, b, c and also divided image data at successive memory addresses for all the remaining non-illustrated micromirrors 38 at the inter-readout pitch of 0.9 [μm].

According to the second embodiment, as described above, if the inter-readout pitch for the micromirrors 38 is a rational multiple of the pixel pitch, then when the decision means 43 judges that the inter-readout pitch of 0.9 [μm] is a rational multiple 9/5 of the pixel pitch of 0.5 [μm], the divided image data generating means 44 generates divided image data 2041 through 2049 in phase with the recording dot forming positions in the scanning direction of the micromirrors 38 from the resolution-converted image data 214 which are produced by converting the resolution of the pixel pitch of 0.5 [μm] into a higher resolution of 0.1 [μm] representing an aliquot part of the inter-readout pitch of 0.9 [μm] and also from the exposure trajectory information, and stores the generated divided image data 2041 through 2049 in the hard disk 82 or the main memory 84.

Accordingly, if the inter-readout pitch of 0.9 [μm] is not an integral multiple, but a rational multiple 9/5 of the pixel pitch of 0.5 [μm], then the divided image data generating means 44 generates divided image data 2041 through 2049 in phase with the image forming positions in the scanning direction of the micromirrors 38 of the DMDs 36 from the resolution-converted image data 214 which are produced by converting the resolution of the pixel pitch of 0.5 [μm] into a higher resolution of 0.1 [μm] to produce divided image data of the nine types such that the inter-readout pitch of 0.9 [μm] is exactly divisible [meaning that when a real number A (A=0.9) is divided by a real number B (B=0.1), an integral quotient C is produced without a remainder], and stores the divided image data 2041 through 2049 in the hard disk 82 or the main memory 84. Consequently, the divided image data 2041 through 2049 at successive memory addresses are obtained.

A third embodiment will be described below.

According to the third embodiment, an arrangement is provided to perform high-speed access control for reading out memory in the case where the substrate 12 is expanded and contracted in the scanning direction and an image formed on the image recording surface needs to be corrected for its length.

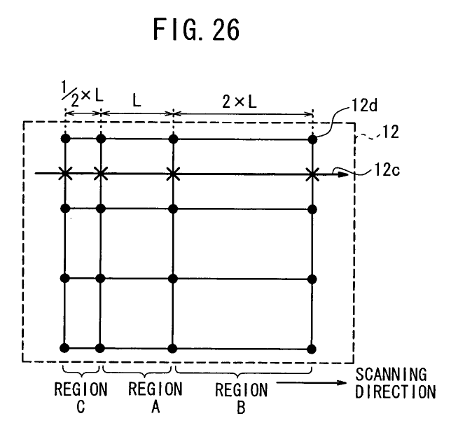

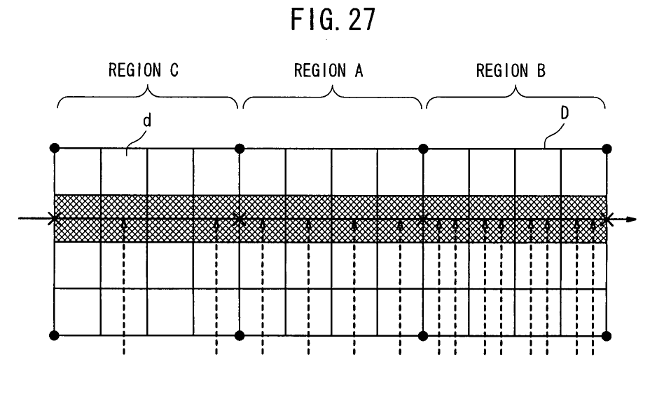

If the substrate 12 is expanded and contracted in the scanning direction as shown in FIG. 26, for example, then the number of mirror data acquired from one pixel data d of the image data D may be varied depending on the expansion and contraction. Specifically, if the substrate 12 is expanded and contracted in the scanning direction to have detected position information 12d and passage position information 12c related to each other as shown in FIG. 26 such that there are a region A wherein the interval between the detected position information 12d adjacent to each other in the scanning direction is of an ideal length L, a region B wherein the interval is twice the length L as the substrate 12 is expanded in the scanning direction, and a region C wherein the interval is one-half of the length L as the substrate 12 is contracted in the scanning direction, then as shown in FIG. 27, one mirror data is acquired per one pixel data d in the region A, two mirror data are acquired per one pixel data d in the region B, and one mirror data is acquired per two pixel data in the region C. The dotted-line arrows in FIG. 27 represent the numbers of mirror data acquired in the regions and the pixel data d corresponding to those mirror data.

For acquiring one mirror data per two pixel data, one of two pixel data may be selected and acquired as mirror data. By thus varying the numbers of mirror data depending on how the substrate 12 is expanded and contracted as described above, the substrate 12 can be exposed at a desired position to a desired exposure image.

A process of correcting image data for length and successively accessing pixel data from phase-divided image data will be described below.

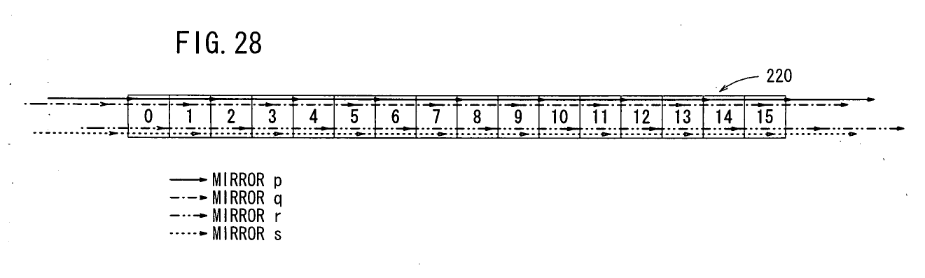

As shown in FIG. 28, it is assumed that four mirrors p, q, r, s having a feed pitch of 1 [μm] are used to form an image from image data 220 having a pixel pitch of 0.5 [μm].

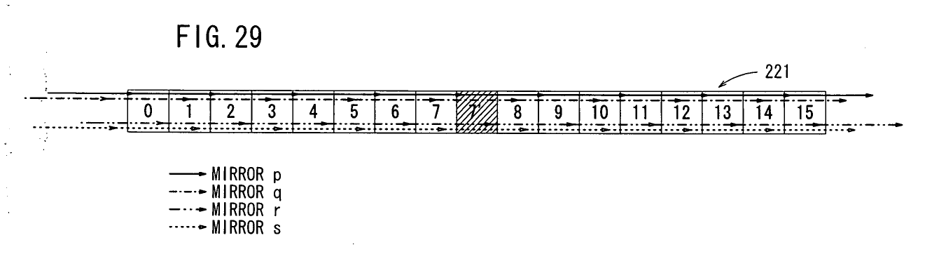

As shown in FIG. 29, if a pixel “7′” having the same pixel data as a pixel “7” is inserted into the image data 220, producing image data 221, then the phase relative to scanning trajectories (exposure trajectories) of the mirrors p, q, r, s changes across the inserted pixel.

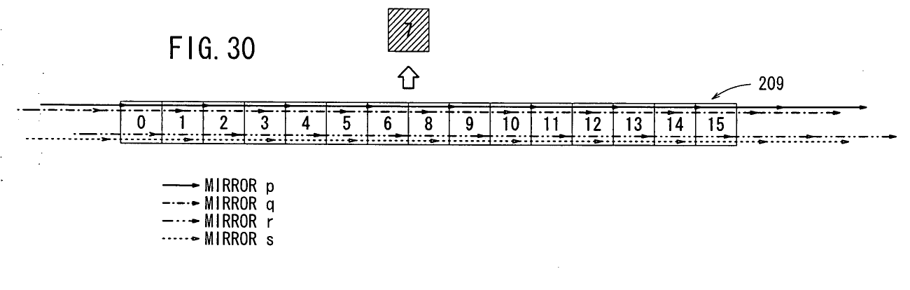

Similarly, as shown in FIG. 30, if the pixel “7” is deleted from the image data 220, producing image data 209, then the phase relative to scanning trajectories of the mirrors p, q, r, s changes across the deleted pixel.

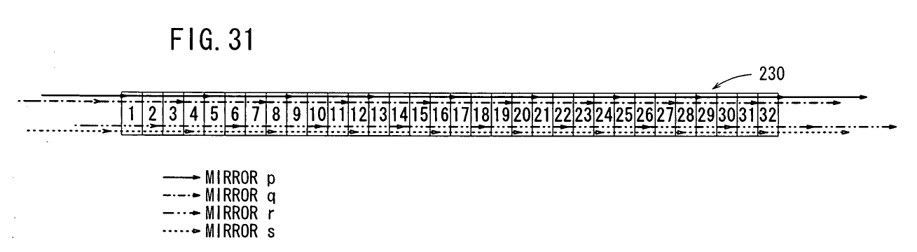

A data access process for accessing pixel data from the divided image data thus corrected for length while retaining the succession of memory addresses as much as possible will be described below, referring to FIGS. 31 through 36B.

FIG. 31 shows the phase relationship between image data 230 made up of pixels “1-32” to be corrected for length and the mirrors p, q, r, s.

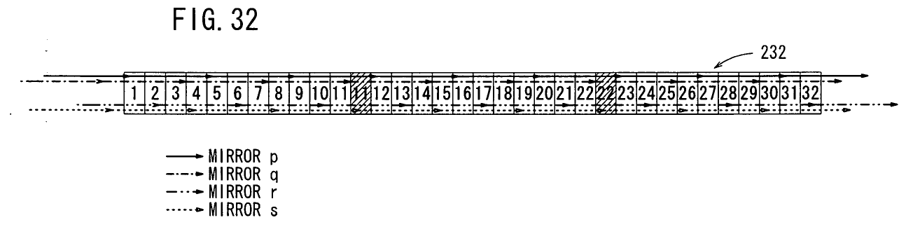

FIG. 32 shows the phase relationship between the mirrors p, q, r, s and image data 232 corrected for length, which are produced by adding two pixel data, i.e., the pixel data of a pixel “11” and the pixel data of a pixel “22”, to the image data 230 to be corrected for length.

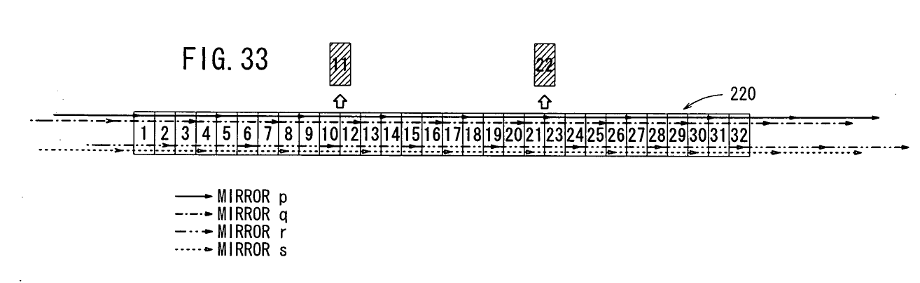

FIG. 33 shows the phase relationship between the mirrors p, q, r, s and image data 220 corrected for length, which are produced by deleting two pixel data, i.e., the pixel data of the pixel “11” and the pixel data of the pixel “22”, from the image data 230 to be corrected for length.

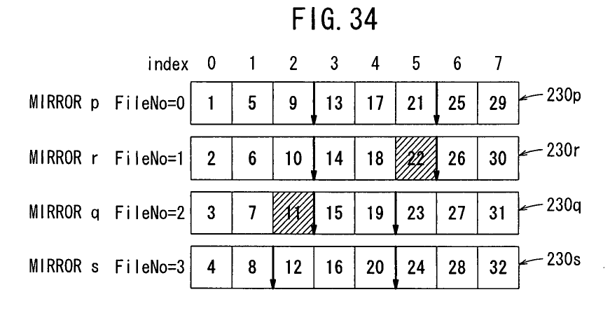

Divided image data for the image data 230 to be corrected for length with respect to the mirrors p, q, r, s are obtained as divided image data 230p, 230q, 230r, 230s as shown in FIG. 34 from the positions of the tip ends of the arrows on the trajectories of the mirrors p, q, r, s, as shown in FIG. 31.

In FIG. 34 which shows the divided image data 230p, 230q, 230r, 230s to be corrected for length, Index “0, 1, . . . , 7” represents the direction of successive memory addresses. As shown in FIG. 34, file numbers assigned to the divided image data 230p, 230q, 230r, 230s are indicated by File No=0, 1, 2, 3. In FIG. 34, the downward arrows represent information of data addition, and the hatched areas represent information of data deletion.

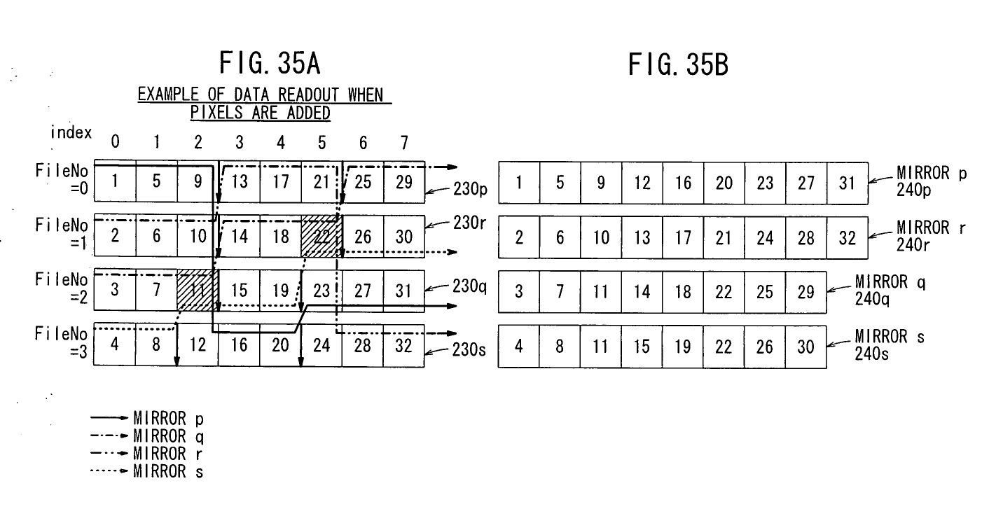

A process for reading out divided image data for the mirror p for data addition, for example, will be described below. For reading out the pixels “1, 5, 9”, the divided image data 230p is assigned to the mirror p as can be seen by referring to FIGS. 32, 34, and 35A. For reading out the pixels “12, 16, 20” for next exposure, the divided image data 230s is assigned to the mirror p as can be seen by referring to the downward arrows, and for reading out the pixels “23, 27, 31” for next exposure, the divided image data 230q is assigned to the mirror p as can be seen by referring to the downward arrows. By thus reading the pixel data, readout image data 240P with two pixel data added are properly obtained as shown in FIG. 35B.

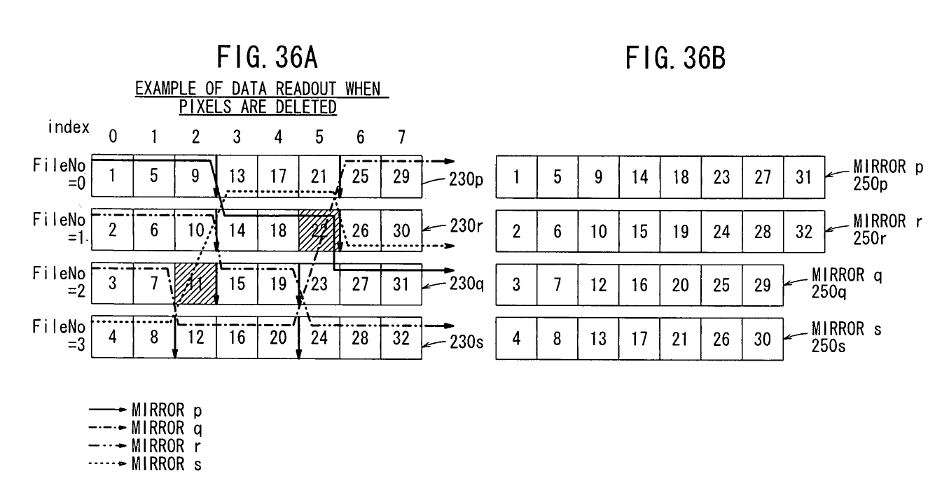

Similarly, a process for reading out divided image data for the mirror p for data deletion, for example, will be described below. For reading out the pixels “1, 5, 9”, the divided image data 230p is assigned to the mirror p as can be seen by referring to FIGS. 33, 34, and 36A. For reading the pixels “14, 18” for next exposure, the divided image data 230r is assigned to the mirror p as can be seen by referring to the deleted pixel “11”, and for reading the pixels “23, 27, 31” for next exposure, the divided image data 230q is assigned to the mirror p as can be seen by referring to the deleted pixel “22”. By thus reading the pixel data, readout image data 250p with two pixel data deleted are properly obtained as shown in FIG. 36B.

According to the third embodiment, as described above, for adding pixel data to or deleting pixel data from the image data 230 to be corrected for length in order to correcting the length of an image to be formed on the substrate 12, the divided image data generating means 44 adds corresponding pixel data to or deletes corresponding pixel data from the divided image data 230p, 230q, 230r, 230s to be corrected for length in order to access and read the successive memory address continuously subsequently to the addition or deletion of the pixel data in the scanning direction. If the divided image data 230p, 230q, 230r, 230s to be corrected for length are stored with addition information marked by downward arrows or deletion information marked by hatched areas, as shown in FIG. 34, even when the divided image data 230p, 230q, 230r, 230s are corrected for length, the successive memory addresses can continuously be accessed and read from the hard disk 82 or the main memory 84 by reassigning the divided image data 230p, 230q, 230r, 230s according to the marks.

If memory addresses where pixel data for deleting or adding image recording dots are stored are skipped (for deletion) or repeated (for addition), rather than actually adding or deleting pixel data, then the divided image data 230p, 230q, 230r, 230s can be corrected for length without reassigning themselves.

A fourth embodiment wherein the present invention is applied to a one-beam scanning exposure apparatus will be described below.

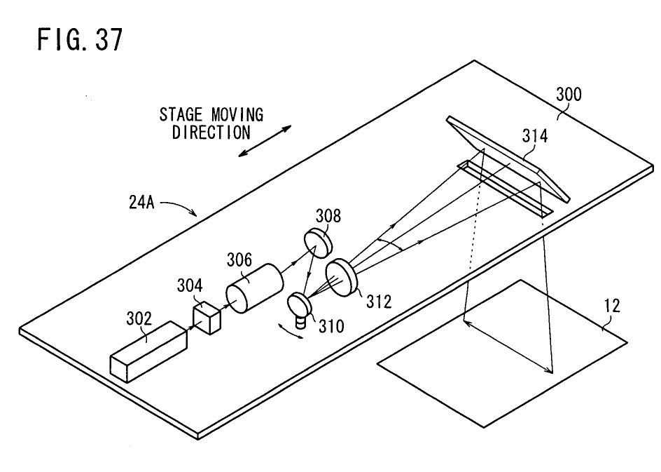

FIG. 37 is a perspective view of a one-beam scanning exposure apparatus 24A used to replace the scanner 24 of the exposure apparatus 10 shown in FIG. 1. The one-beam scanning exposure apparatus 24A includes an optical table 300 with a laser generator 302 mounted thereon. A laser beam output from the laser generator 302 is turned on and off by an optical modulator 304 based on an image signal, and is applied via a lens 306 and a reflecting mirror 308 to a scanning galvanometer mirror 310 serving as an optical deflector.

The laser beam is deflected in reciprocating scanning cycles by the galvanometer mirror 310, and travels via a scanning lens 312, a reflecting mirror 314 and a slit defined in the optical table 300 and scans the substrate 12 in reciprocating strokes. The optical deflector in the reciprocating scanning side may comprise a resonant mirror instead of the galvanometer mirror 310.

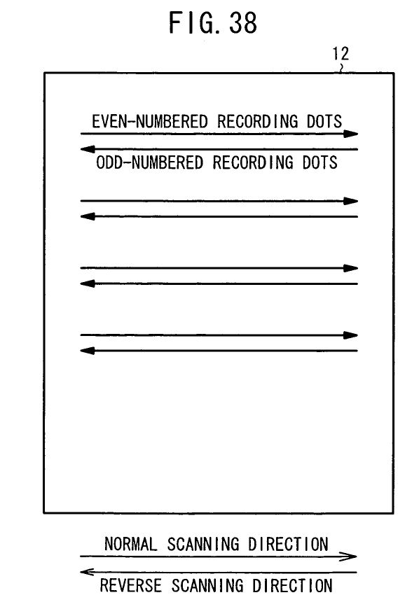

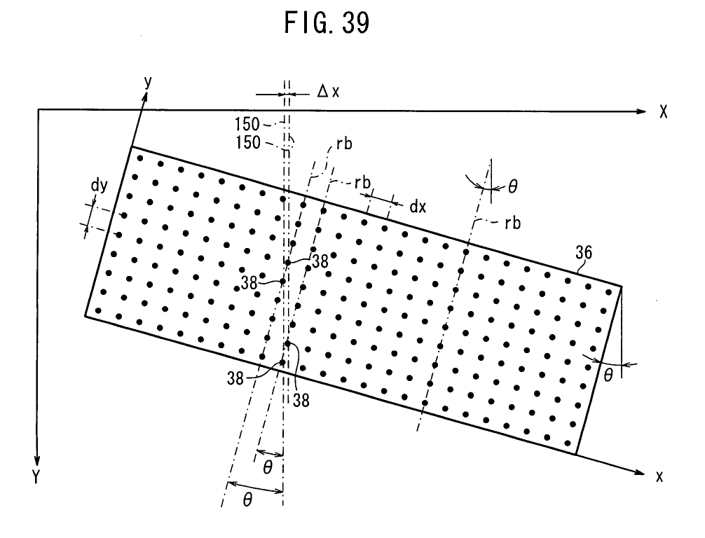

As shown in FIG. 38, the one-beam scanning exposure apparatus 24A scans the substrate 12 from an upper left area to the right (in a normal scanning direction) on the substrate 12 to form a sequence of intermittent image recording dots, i.e., even-numbered image recording dots, on the substrate 12, and then scans the substrate 12 from an upper right area to the left (in a reverse scanning direction opposite to the normal scanning direction) on the substrate 12 to form a sequence of intermittent image recording dots, i.e., odd-numbered image recording dots, which fill up the above intermittent sequence of image recording dots, i.e., even-numbered image recording dots, thereby forming an image made of sequences of successive image recording dots on the substrate 12.

In this case, the feed pitch (inter-readout pitch) may be twice the pixel pitch on the substrate 12.

By making the image data in the normal and reverse scanning directions of the galvanometer mirror 310 in phase, and by storing the image data as divided image data with the normal scanning direction being aligned with the direction of successive memory addresses and also with the reverse scanning direction being aligned with the direction of successive memory addresses, in the hard disk 82 or the main memory 84, the memory access means 45 can successively access image data to read them out from the divided image data at a high speed (in a short time). Deformations of the substrate 12 may be absorbed by changing the image data, and the paths for acquiring mirror data on the image which correspond to the exposure trajectories may not be changed, or in other words, the lines for reading out the data may not be changed.

In the first through third embodiments, the exposure apparatus 10 having the DMDs 36 as spatial light modulators as image recording dot forming elements have been described above. However, transmissive spatial light modulators may also be used in addition to those reflective spatial light modulators. For example, liquid crystal cells may be used, and LEDs (light-emitting diodes) may be used.

In the first through third embodiments, the exposure apparatus of the so-called flat-bed type have been described above. However, the exposure apparatus may be of the so-called outer-drum type or inner-drum type which has a drum with a photosensitive material wound on its outer or inner surface.

The substrate 12 to be exposed in the first through fourth embodiments is not limited to a printed-wiring board, but may be a substrate for use in a flat panel display. The substrate 12 may be in the form of a sheet or may be an elongate shape (flexible substrate or the like).

The present invention is also applicable to the image recording in a printer of the ink jet type or the like. For example, image recording dots may be formed by expelling ink in the same manner as with the present invention. Specifically, a recording dot forming region according to the present invention may be considered to be a region to which the ink expelled from each nozzle of the printer of the ink jet type is applied.

The memory for storing image data may be an SRAM in addition to a DRAM used as the main memory 84. If an SRAM is used, then the direction in which bits can successively be accessed may be defined as the direction of successive addresses.

The divided image data generated by the divided image data generating means 44 may be compressed by the data compressing means 51 and then stored in the main memory 84. If the run length encoding (RLE) process for compressing data of a succession of identical symbols by expressing the data with the “symbol” and the “number of symbols”, then when the compressed data are directly read out, they serve as compressed mirror data (time-series data to be given to the mirrors). If the data are read out in each unit of given bits, then the compressed data are partly decoded at the boundaries between the read units, and the rest of the compressed data remain compressed.

An image is preferably recorded on the substrate 12 by a multiple exposure process for forming image recording dots at closely spaced positions with beams from two or more micromirrors 38 which are spaced from each other on a scanning line 150 along the scanning direction (Y direction). The multiple exposure process is realized by placing a beam sequence rb whose angle θ is closer to the scanning direction in overlapping relation to another adjacent beam sequence rb in the scanning direction Y.

A modification (resampling process) of the second embodiment for dividing the image data by phase division if the inter-readout pitch is a rational multiple of the pixel pitch will be described below.

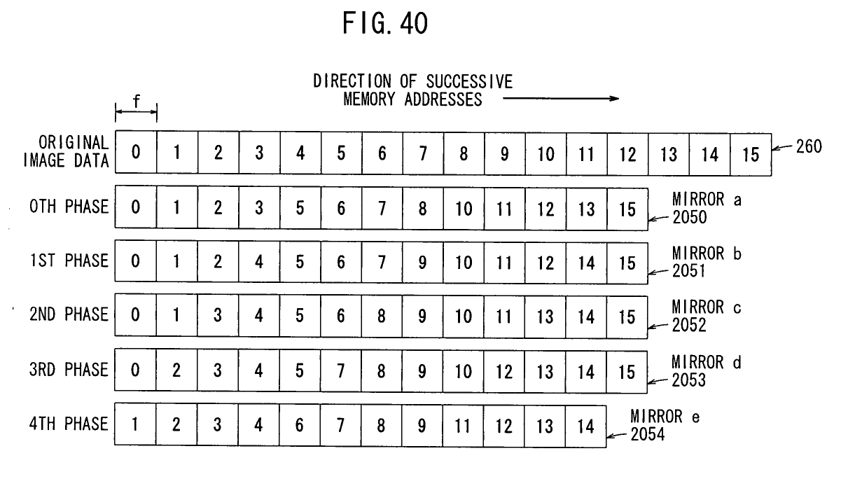

FIG. 40 shows an example in which original image data 260 having a pixel pitch f prior to being divided are recorded by images (image recording dot forming elements) of five (0th phase through 4th phase) micromirrors a through e of different readout phases having an inter-readout pitch of 1.25×f.

The readout phase of the micromirror a of the 0th phase is 0, the readout phase of the micromirror b of the 1st phase is 0.25, the readout phase of the micromirror c of the 2nd phase is 0.5, the readout phase of the micromirror d of the 3rd phase is 0.75, and the readout phase of the micromirror e of the 4th phase is 1.

In view of the fact that the pixel pitch f is a rational multiple P of the inter-readout pitch of 1.25f, the numerator R of the irreducible fraction P=R/Q representing the rational multiple P represents the number of different phases of the image recording dot forming elements. Specifically, the numerator R=5 of P=R/Q=5/4=1.25 represents the number of different phases (0th phase through 4th phase).

The divided image data of the Nth (N=0, 1, 2, 3, 4) phase can be generated by reading out pixel data in a sequence determined by the following equation (1) from the original image data 260 with respect to each of the image recording dot forming elements of different readout phases:

[P×i(i=0, 1, . . . )+N/4=Pi+N/Q] (1)

where [Z] represents an integer part of Z.

Specifically, since divided image data 2050 (see FIG. 40) to be given to the mirror a of the N=0th phase are represented by an integer part of 1.25×i (i=0, 1, 2 . . . ), the divided image data 2050 are generated by reading out, from the image data 260, pixel data in a sequence determined by [0]=0, [1.25]=1, [2.5]=2, [3.75]=3, [5]=5, [6.25]=6, [7.5]=7, [8.75]=8, [10]=10, [11.25]=11, [12.5]=12, [13.75]=13, [15]=15, . . . .

Furthermore, since divided image data 2051 to be given to the mirror b of the N=1st phase are represented by an integer part of 1.25×i (i=0, 1, 2 . . . )+0.25, the divided image data 2051 are generated by reading out, from the image data 260, pixel data in a sequence determined by [0.25]=0, [1.5]=1, [2.75]=2, [4] 4, [5.25]=5, [6.5]=6, [7.75]=7, [9]=9, [10.25]=10, [11.5]=11, [12.75]=12, [14]=14, [15.25]=15, . . . . If the inter-readout pitch, which is 1.25f in the example shown in FIG. 40, is P times a rational of the pixel pitch f, then the number R of different phases of image recording dot forming elements is determined by an integer which minimizes the value P×Q where Q is an integer. In the example shown in FIG. 40, the number R of different phases is determined as P×Q=1.25×4=5.

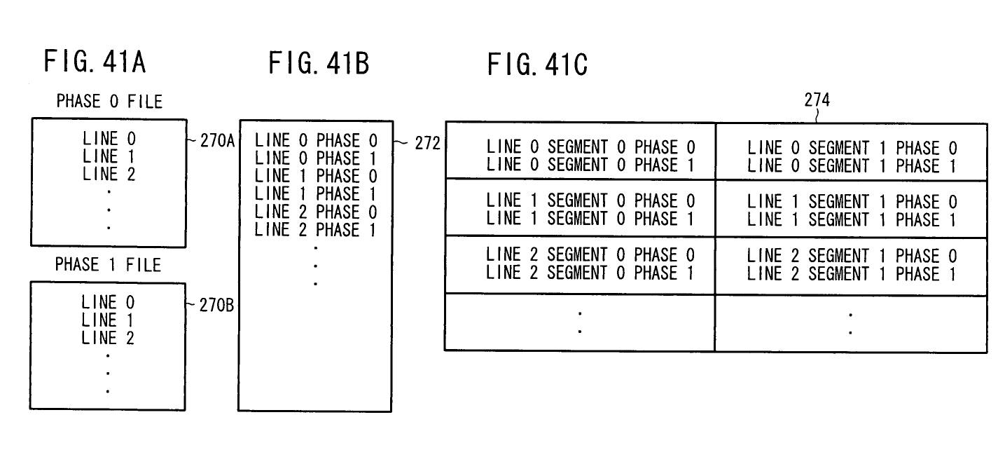

The above divided image data may be stored as files of divided image data 270A, 270B of completely different phases, as shown in FIG. 41A, or may be grouped for phase-divided lines, as shown in FIG. 41B, or may be divided into segments in a line direction which may be phase-divided and stored, as shown in FIG. 41C.

Specifically, the divided image data may be phase-divided and the divided image data 270A, 270B may be formed as separate files, as shown in FIG. 41A. The divided image data may be placed in different storage areas for respective phases in one file. For example, as shown in FIG. 41B, divided image data 272 may comprise data of respective phases (phase 0, phase 1) alternately positioned for respective lines in one file, or as shown in FIG. 41C, divided image data 274 may comprise data of respective phases alternately positioned in segment-divided units (segment 0, segment 1). In this case, the data corresponding to the respective phases may be regarded as different divided image data. Line numbers (line 0, line 1, line 2, . . . ) in FIGS. 41B and 41C correspond to lines numbers in FIG. 41A.

1. An image recording apparatus for relatively moving a plurality of image recording dot forming elements in a scanning direction on an image recording surface at a predetermined feed pitch based on image data comprising pixel data for forming an image so as to form a sequence of image recording dots on said image recording surface, thereby forming the image on said image recording surface, comprising:
storage means for storing said image data as divided image data if a pixel pitch of said pixel data and said feed pitch are different from each other;
wherein said divided image data are divided such that said image data are in phase with respective recording dot forming positions in said scanning direction of said image recording dot forming elements, and said scanning direction and a direction of successive memory addresses of said storage means are aligned with each other.

2. An image recording apparatus for relatively moving a plurality of image recording dot forming elements in a scanning direction on an image recording surface based on image data comprising pixel data so as to form a sequence of image recording dots on said image recording surface, thereby forming an image on said image recording surface, comprising:
storage means for storing divided image data divided from said image data for each of phases in said image data along a readout direction of readout positions for said pixel data for controlling said image recording dot forming elements.

3. An image recording apparatus according to claim 2, further comprising:
access means for reading out said pixel data to be given to said image recording dot forming elements from said divided image data for each of said phases.

4. An image recording apparatus according to claim 3, wherein said access means reads out said pixel data from said divided image data for each of said image recording dot forming elements.

5. An image recording apparatus according to claim 2, wherein said divided image data are stored such that said scanning direction and the direction of successive memory addresses of said storage means are aligned with each other.

6. An image recording apparatus according to claim 5, further comprising:
access means for reading out said pixel data to be given to said image recording dot forming elements from said divided image data for each of said phases, wherein said access means successively reads out a plurality of said pixel data from said divided image data for each of said image recording dot forming elements.

7. An image recording apparatus according to claim 5, wherein depending on relative movement of said image recording dot forming elements, said pixel data read for each of said image recording dot forming elements are given in a time sequence to said image recording dot forming elements to form said sequence of image recording dots.

8. An image recording apparatus according to claim 2, wherein said image recording dot forming elements which are arrayed in the scanning direction and spaced from each other record said image recording dots in respective positions which are close to each other.

9. An image recording apparatus according to claim 2, wherein said phases corresponding to the respective image recording dot forming elements are determined depending on the array pattern of said image recording dot forming elements with respect to said image recording surface.

10. An image recording apparatus according to claim 2, wherein each of said divided image data is compressed.

11. An image recording apparatus according to claim 10, wherein said pixel data are read out in an at least partly compressed state from said divided image data corresponding to said readout phases with respect to each of said image recording dot forming elements.

12. An image recording apparatus according to claim 2, wherein if an inter-readout pitch of the readout positions for said pixel data is an integral multiple of said pixel pitch, said divided image data are divided into pixel data sequences perpendicular to said scanning direction.

13. An image recording apparatus according to claim 2, wherein if an inter-readout pitch of the readout positions for said pixel data is a rational multiple of said pixel pitch, said divided image data are generated in phase with respective recording dot forming positions in said scanning direction of said image recording dot forming elements from resolution-converted image data whose pixel pitch has been converted into a high resolution by which said inter-readout pitch is divisible.

14. An image recording apparatus according to claim 2, wherein if said pixel pitch is rational P times said inter-readout pitch, the number of different readout phases of said image recording dot forming elements is represented by the numerator R of an irreducible fraction P=R/Q representing said rational P, and said divided image data of an Nth (N=0, 1, . . . , Q−1) phase are generated by reading out pixel data in a sequence determined by an integer part of P×i (i=0, 1, . . . )+N/Q from said image data with respect to each of said image recording dot forming elements of the different readout phases.

15. An image recording apparatus according to claim 2, wherein if pixel data are added to or deleted from said image data to correct a length of said image to be formed on said image recording surface, corresponding pixel data are added to or deleted from said divided image data, and said divided image data are reassigned to each of said image recording dot forming elements to allow successive memory addresses of said storage means to be continuously accessed and read subsequently to the added or deleted pixel data in said scanning direction.

16. An image recording apparatus according to claim 2, wherein if pixel data are read out from said storage means which stores said divided image data to correct a length of said image to be formed on said image recording surface, the pixel data are read out by skipping or repeating reading of a memory address which stores pixel data for deleting or adding image recording dots.

17. A method of generating image data for use in relatively moving a plurality of image recording dot forming elements in a scanning direction on an image recording surface at a predetermined feed pitch based on image data comprising pixel data for forming an image so as to form a sequence of image recording dots on said image recording surface, thereby forming an image on said image recording surface, comprising:
a divided image data generating step of storing, in a storage means, said image data as divided image data if a pixel pitch of said pixel data and said feed pitch are different from each other, said divided image data being divided such that said image data are in phase with respective recording dot forming positions in said scanning direction of said image recording dot forming elements and said scanning direction and a direction of successive memory addresses are aligned with each other.

18. A method of generating image data for use in relatively moving a plurality of image recording dot forming elements in a scanning direction on an image recording surface based on image data comprising pixel data so as to form a sequence of image recording dots on said image recording surface, thereby forming an image on said image recording surface, comprising:
a dividing step of generating divided image data divided from said image data for each of phases in said image data along a readout direction of readout positions for said pixel data for controlling said image recording dot forming elements; and
a storing step of storing said divided image data in a storage means.

19. A method of generating image data according to claim 18, further comprising:
an access step of reading out, with access means, said pixel data to be given to said image recording dot forming elements from said divided image data for each of said phases.

20. A method of generating image data according to claim 19, wherein said access means reads out said pixel data from said divided image data for each of said image recording dot forming elements.

21. A method of generating image data according to claim 18, wherein in said storing step, said divided image data are stored such that said scanning direction and the direction of successive memory addresses of said storage means are aligned with each other.

22. A method of generating image data according to claim 21, further comprising
an access step of reading out, with access means, said pixel data to be given to said image recording dot forming elements from said divided image data for each of said phases,
wherein in said access step, a plurality of said pixel data are successively read out from said divided image data for each of said image recording dot forming elements.

23. A method of generating image data according to claim 21, wherein for forming said sequence of image recording dots, depending on relative movement of said image recording dot forming elements, said pixel data read out for each of said image recording dot forming elements are given in a time sequence to said image recording dot forming elements to form said sequence of image recording dots.

24. A method of generating image data according to claim 18, wherein said image recording dot forming elements which are arrayed in the scanning direction and spaced from each other record said image recording dots in respective positions which are close to each other.

25. A method of generating image data according to claim 18, wherein said phases corresponding to the respective image recording dot forming elements are determined depending on the array pattern of said image recording dot forming elements with respect to said image recording surface.

26. A method of generating image data according to claim 18, wherein each of said divided image data is compressed.

27. A method of generating image data according to claim 26, wherein said pixel data are read out in an at least partly compressed state from said divided image data corresponding to said readout phases with respect to each of said image recording dot forming elements.

28. A method of generating image data according to claim 18, wherein if an inter-readout pitch of the readout positions for said pixel data is an integral multiple of said pixel pitch, said divided image data are divided into pixel data sequences perpendicular to said scanning direction.

29. A method of generating image data according to claim 18, wherein if an inter-readout pitch of the readout positions for said pixel data is a rational multiple of said pixel pitch, in said divided image data generating step, said divided image data are generated in phase with respective recording dot forming positions in said scanning direction of said image recording dot forming elements from resolution-converted image data whose pixel pitch has been converted into a high resolution by which said inter-readout pitch is divisible, and are stored in said storage means.

30. A method of generating image data according to claim 18, wherein if said pixel pitch is rational P times said inter-readout pitch, the number of different readout phases of said image recording dot forming elements is represented by the numerator R of an irreducible fraction P=R/Q representing said rational P, and said divided image data of an Nth (N=0, . . . , Q−1) phase are generated by reading out pixel data in a sequence determined by an integer part of P×i (i=0, 1, . . . )+N/Q from said image data with respect to each of said image recording dot forming elements of the different readout phases.

31. A method of generating image data according to claim 18, wherein if pixel data are added to or deleted from said image data to correct a length of said image to be formed on said image recording surface, in said divided image data generating step, corresponding pixel data are added to or deleted from said divided image data, and said divided image data are reassigned to each of said image recording dot forming elements to allow successive memory addresses of said storage means to be continuously accessed and read subsequently to the added or deleted pixel data in said scanning direction.

32. A method of generating image data according to claim 18, further comprising:
after said divided image data generating step, a length correction reading out step of, if pixel data are read out from said storage means which stores said divided image data to correct a length of said image to be formed on said image recording surface, reading out the pixel data by skipping or repeating reading of a memory address which store pixel data for deleting or adding image recording dots.

33. An image recording apparatus for relatively moving image recording dot forming elements in a normal scanning direction on an image recording surface at a predetermined feed pitch based on image data comprising pixel data for forming an image, thereby to form an intermittent sequence of image recording dots on said image recording surface, and relatively moving image recording dot forming elements in a reverse scanning direction which is opposite to said normal scanning direction at said predetermined feed pitch, thereby to form an intermittent sequence of image recording dots on said image recording surface to fill up said intermittent sequence of image recording dots, thereby forming an image made up of a successive sequence of image recording dots on said image recording surface, comprising:
storage means for storing said image data as divided image data if a resolution of the image formed on said image recording surface and said predetermined feed pitch are different from each other;
wherein said divided image data comprise divided image data such that they are in phase with respective recording dot forming positions in said normal scanning direction and said reverse scanning direction of said image recording dot forming elements, and said normal scanning direction and a direction of successive memory addresses are aligned with each other, and said reverse scanning direction and the direction of successive memory addresses are aligned with each other.

34. A method of generating image data for use in relatively moving image recording dot forming elements in a normal scanning direction on an image recording surface at a predetermined feed pitch based on image data comprising pixel data for forming an image so as to form an intermittent sequence of image recording dots on said image recording surface, and relatively moving said image recording dot forming elements in a reverse scanning direction which is opposite to said normal scanning direction at said predetermined feed pitch so as to form an intermittent sequence of image recording dots on said image recording surface to fill up said intermittent sequence of image recording dots, thereby forming an image made up of a successive sequence of image recording dots on said image recording surface, comprising
a divided image data generating step of storing, in a storage means, said image data as divided image data if a resolution of the image formed on said image recording surface and said predetermined feed pitch are different from each other, said divide image data comprising divided image data such that they are in phase with respective recording dot forming positions in said normal scanning direction and said reverse scanning direction of said image recording dot forming elements, and said normal scanning direction and a direction of successive memory addresses are aligned with each other, and said reverse scanning direction and the direction of successive memory addresses are aligned with each other.
